(19) United States
(12) Patent Application Publication
(10) Pub. No.: US 2022/0118621 A1
(43) Pub. Date: Apr. 21, 2022

(54) ENHANCED ROBOT SAFETY PERCEPTION AND INTEGRITY MONITORING

(71) Applicant: Intel Corporation, Santa Clara, CA (US)

(72) Inventors: Michael PAULITSCH, Ottobrunn (DE); Florian GEISSLER, Munich (DE); Ralf GRAEFE, Haar (DE); Tze Ming HAU, Seremban2 (MY); Neslihan KOSE CIHANGIR, Munich (DE); Ying Wei LIEW, Sg Ara (MY); Fabian Oboril, Karlsruhe (DE); Yang PENG, Munich (DE); Rafael ROSALES, Unterhaching (DE); Kay-Ulrich SCHOLL, Malsch (DE); Norbert STOEFFLER, Graefeling (DE); Say Chuan TAN, Penang (MY); Wei Seng YEAP, Penang (MY); Chien Chern YEW, Penang (MY)

(21) Appl. No.: 17/561,747

(22) Filed: Dec. 24, 2021

(51) Int. Cl. B25J 9/16; B25J 13/08

(52) U.S. Cl. CPC B25J 9/1676; B25J 9/1666; B25J 13/089; B25J 9/1692; B25J 13/085; B25J 9/1697

(57) ABSTRACT

Disclosed herein are systems, devices, and methods for improving the safety of a robot. The safety system may determine a safety envelope of a robot based on a planned movement of the robot and based on state information about a load carried by a robot. The state information may include a dynamic status of the load. The safety system may also determine a safety risk based on a detected object with respect to the safety envelope. The safety system may also generate a mitigating action to the planned movement if the safety risk exceeds a threshold value.

### TECHNICAL FIELD

The disclosure relates generally to robot safety perception and the integrity of the systems that support robot safety perception. In particular, the disclosure relates to systems, devices, and methods for human safety in environments where robots and humans may collaborate together or near each other to accomplish work tasks.

### BACKGROUND

Autonomous robots are becoming increasingly widespread in work and personal environments. In environments were robots may work near humans, ensuring that the robot operates safely may take on greater importance. This may be especially true, for example, where a robot may move about an environment with a load that may differ from one moment to the next. Throughout a its workday, for example, a robot in a warehouse may onload and/or offload different objects with varying sizes, weights, shapes, distributions, and quantities. As a result of the dynamic nature of the robot's load, the robot may not move as expected (e.g., as compared to an unloaded robot), and the robot's varying load may create unpredictable safety risks associated with the robot's planned movements. In addition, today's robot may have limited on-board processing resources, meaning the robot may not be able to adequately analyze the environment for unexpected objects, unexpected situations, and/or unplanned actions that may occur frequently in work environments that are shared with humans. As such, human-robot shared environments may impose too high of a processing burden on the robot, and the robot may not be able to adequately assess the safety of a given situation and to safely respond. In addition, as robot control systems become more complex in an attempt to meet the increased safety needs of robots in human-robot shared environments, the number of potential failure locations in the robot control system may increase, and with it, the risk of a critical safety issue associated with such a failure.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIGS. 1A-1C illustrate the dynamic nature of an exemplary load of a robot;

FIG. 2 shows an exemplary robot safety system for adjusting a robot's movement plan based on state information about the robot;

FIG. 3 shows an exemplary diagram of a robot safety service system for providing services for a robot;

FIG. 4 depicts an exemplary flow diagram for diagnostic services that may be provided to a robot;

FIG. 5 depicts an exemplary flow diagram for cognitive assistance services that may be provided to a robot;

FIG. 6 depicts an exemplary flow diagram for localization assistance that may be provided to a robot;

FIG. 7 shows an exemplary flow diagram for an emergency trigger service that may be provided to a robot;

FIG. 8 shows an exemplary flow diagram for remote takeover control of a robot;

FIG. 9 illustrates an exemplary flow diagram for a monitoring service for a robot;

FIG. 10 illustrates an exemplary flow diagram for an integrity-checking system for a robot;

FIG. 11 illustrates an exemplary schematic drawing of a device for improving the safety of a robot; and

FIGS. 12-16 each depict an exemplary schematic flow diagram of a method for improving the safety of a robot.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [. . . ], etc., where “[. . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc., where “[. . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D) (Point', among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “robot” may be understood to include any type of digitally controllable machine that is designed to perform a task or tasks. By way of example, a robot may be an autonomous mobile robot (AMR) that may move within an area (e.g., a manufacturing floor, an office building, a warehouse, etc.) to perform a task or tasks; or a robot may be understood as an automated machine with arms, tools, and/or sensors that may perform a task or tasks at a fixed location; or a combination thereof.

When robots share workspaces with humans, safety may become a more important issue. The systems that may monitor the safety of a robot may need to account for the unpredictable nature of human movement in the workspace. Such human inconsistencies may create serious safety risks for the human or others within the vicinity of the robot. In addition, the impact of the robot on the safety of a situation may also vary over time, as the load a robot may be carrying may change in terms of size, shape, position, balance, etc., and may impact the motion of the robot.

In addition, today's robot may have limited on-board processing and/or sensing capabilities. This means that the robot may not be able to adequately sense, analyze, and calculate an appropriate response for complex, shared environments with human participants and/or multiple robots, each of which may present unexpected and unplanned situations within the environments that the robot may need to detect and respond to. If the unexpected nature of the objects in the environment imposes too high of a processing and/or sensing burden on the robot, it may be unable to adequately assess the safety of a given situation and to safely respond. As a further complicating factor, as robot control systems become more complex in an attempt to meet the increased processing and/or sensing needs associated with ensuring the safety of robots and humans in a complex environment, the number of potential failure locations within the control system may increase, and with it, the risk of a critical safety issue associated with such a failure.

As should be apparent from the detailed disclosure below, the disclosed robot systems may address safety risks associated with complex environments that may include human participants who may act unpredictably. The robot systems discussed below may not only improve the predictions associated with otherwise unpredictable human movements, but may also improve the planned movements of the robot based on state information about the loads carried by the robot. As discussed below, the robot safety system may make dynamic adjustments to its movement plan based on observations about the dynamic status of its load. In doing so, the robot system may improve the safety of such complex environments.

In addition, the robot systems discussed below may also provide supplementary processing services to a robot, which may be particularly advantageous for robots operating in complex environments that may change quickly, may involve unpredictable human participants, and may include a large number of other objects. The robot may be able to offload certain processing to an off-robot service that provides diagnostic assistance, localization calibration, cognition assistance, emergency assistance, and/or out-of-band control. By offloading certain processing, the robot may be able to react more precisely to a complex constellation of objects in the environment, to unexpected measurements that the robot may encounter, to a loss of position, to a loss of function, and/or to an emergency situation.

In addition, the robot systems discussed below may be able to more efficiently monitor the overall robot system, including its processing pipeline, for critical failures that may present significant safety risks to the robot, other robots, or humans in the environment, if not addressed in a timely manner. This may be especially important for robot systems that involve the fusion of data from numerous sensors and/or have processing distributed across a number of locations, each of which may be associated with a potential failure location and a risk that the failure may cause a critical safety issue. As discussed in more detail below, the disclosed integrity-checking system may provide an improved way of checking that key aspects of the robot system are functioning correctly, which may include the processing pipeline and communications among the various subsystems.

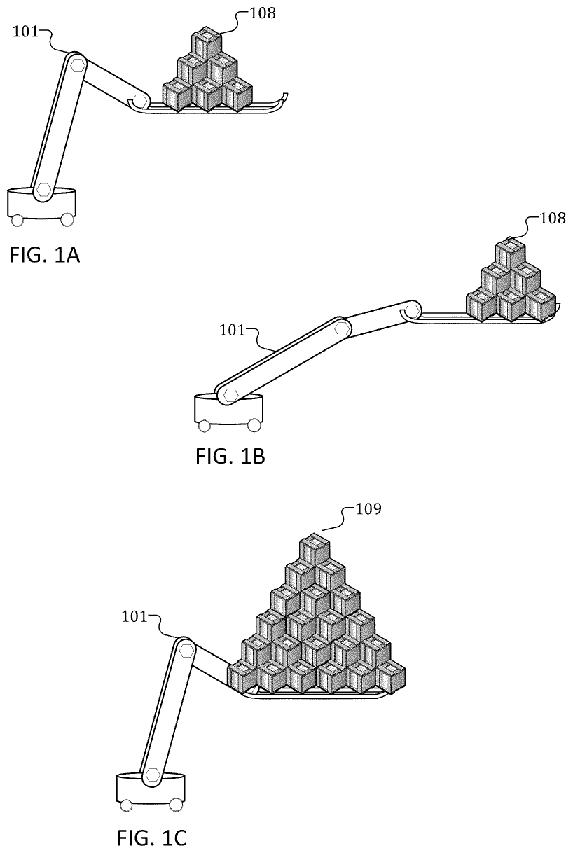

FIGS. 1A-1C illustrate how a robot's load may be dynamic over the course of executing tasks in a work environment. For example, as shown in FIG. 1A, robot 101 is a movable robot with an articulating arm that is holding load 108. The position of the articulating arm of robot 101, combined with the size, weight, distribution, stability, etc., of load 108 may impact the effective size, center of gravity, safe braking distance, available movements, etc. associated with robot 101. In comparing FIG. 1A with FIG. 1B, the articulating arm of robot 101 in FIG. 1B is extended much further forward (e.g., towards the right of the figure), and load 108 is no longer centered on the holding platform of the articulating arm. As a result, the effective size, center of gravity, safe breaking distance, available movements, etc. may be different for robot 101 in the state show in in FIG. 1B as compared to the state shown in FIG. 1A. For example, because the articulating arm of robot 101 is extended much further forward in FIG. 1B, the center of gravity of the robot 101 will also shift much further forward (e.g., towards the right of the figure). This means that when robot 101 is in the state shown in FIG. 1B, it may have a higher risk of toppling over, especially when it attempts to slow down or stop. As another example, given that load 108 in FIG. 1B is no longer centered on the holding platform, but is instead further toward the front of the holding platform, the load 108 in FIG. 1B may have a higher risk of falling off the holding platform, especially if robot 101 were to hit a bump, accelerate quickly, or turn abruptly.

FIG. 1C shows robot 101 with a load 109 that is much larger in size than load 108 shown in FIGS. 1A and 1B. The difference in size, weight, distribution, stability, etc. between load 108 and load 109 may impact the effective size, center of gravity, safe breaking distance, available movements, etc. associated with robot 101. For example, the effective size of the robot 101 (e.g., its height) while carrying load 109 is much larger than when robot 101 is carrying load 108. This means that when carrying load 109, robot 101 may not be able to travel along routes with low clearance. Similarly, if load 109 is much heaver than load 108, robot 101 may not be able to travel across areas of the workspace with a soft-surfaced floor or that have a weight limit. In addition, if load 109 is much heavier than load 108, the robot may require more distance to stop as compared to when it is carrying load 108. As should be appreciated from FIGS. 1A-1C, the dynamic state of robot 101 in terms of its load may impact what is considered safe movement for the robot in each state.

As one example, the mass of the load and its mounting point(s) may change the center of gravity of a loaded robot (e.g., robot 101) as compared to when it is unloaded. For discrete mass points, the center of gravity vector, rₛ, may be given by:

$${r}_{S} = \frac{{\sum }_{i = 0}^{N} {m}_{i} {r}_{i}}{{\sum }_{i = 0}^{N} {m}_{i}}$$

In the formula above, mᵢ and rᵢ are the individual point masses and vectors, respectively. For most robots, the base of support (e.g., the wheels/points at which the robot contacts the ground/surface) stays constant irrespective of the load, so a loaded robot may be more likely to topple over when the center of gravity is higher or further away from the base of support. That means that for any given tilting force (e.g., torque) experienced by the robot, the robot's toppling point may depend on, as examples, the mass of the load and its mounting point. As should be appreciated, a loaded robot that topples over may create safety issues, including significant harm to nearby humans or other robots.

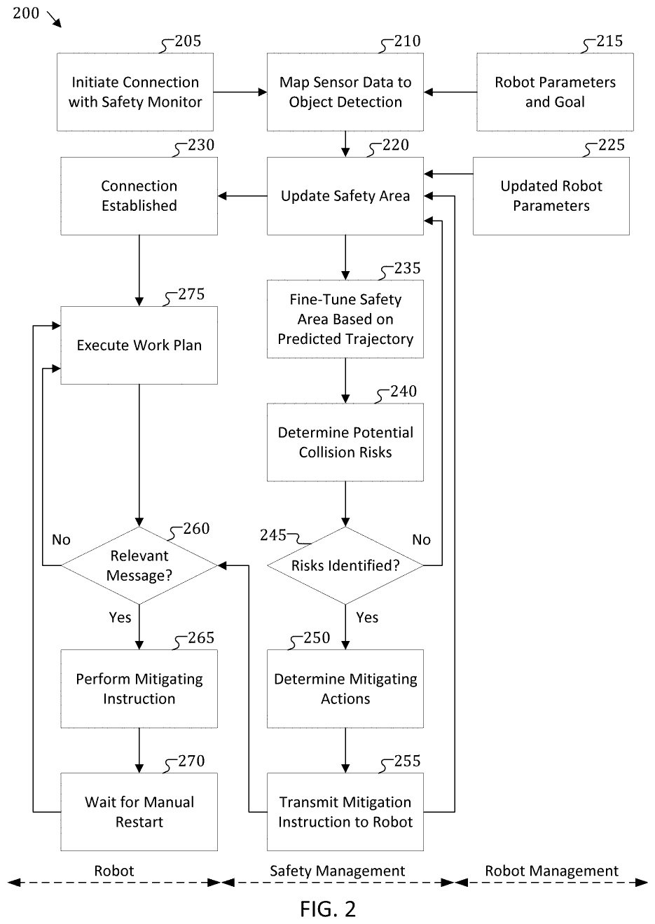

FIG. 2 shows an exemplary robot safety system 200 for adjusting a robot's movement plan based on state information about the robot. Robot safety system 200 may be implemented as a device with a processor that is configured to operate as described herein. The device may operate as part of a server that is remote to the robot (e.g., on an edge- or cloud-based server), may be integrated into the robot, and/or may have processing/sensors that are distributed across various locations. While FIG. 2 shows one implementation where various subsystems may be located on the edge/cloud (e.g., shown in the middle and left columns of FIG. 2 above the “Safety Management” and “Robot Management” arrows) and other subsystems may be located on the robot (e.g., shown as the left-most column of FIG. 2 above the “Robot” arrow), this representation is not intended to be limiting, and any of the depicted subsystems may be distributed in any manner across various locations. As should be appreciated, the robot safety system 200 may also include a receiver, transmitter, and/or transceiver for communicating information among the various processing locations (e.g., between the edge and the robot, between a sensor and the edge, between one robot and another robot, etc.). In addition, the robot safety system 200 may store in a memory any of the data associated with any of the features below, including, as examples, the safety envelope, the safety risk, the mitigating instructions, the robot parameters, the sensor data, the detected objects, and/or the machine learning model.

Robot safety system 200 may initiate, in 201, a connection (e.g., via a transceiver) for requesting safety assistance and for communicating information between the robot and a safety management/robot management subsystem. To respond to the robot's request for safety assistance, the safety management/robot management subsystems may receive sensor information from sensors that monitor the environment (e.g., the robot, the human, and/or other objects in or near the robot's workspace and/or operating area). Such sensors may include, as examples, a depth sensor, a camera, a radar, a light ranging and detection (LiDAR) sensor, a motion sensor, a gyroscopic sensor, an accelerometer, and/or an ultrasonic senor. As should be appreciated, the safety management/robot management subsystems may utilize any type of sensor, and the sensor may be on the robot, remote to the robot, and/or distributed among any number of sensors and any number of sensing locations. The safety management/robot management subsystems may also receive, from 215, basic information about the robot's current motion/trajectory, tasks, goals, and/or other information associated with the robot's movements and planned movements. The robot itself may provide such information or it may be provided by a planning system that centrally coordinates the robot's tasks with other robots. The safety management/robot management subsystems may fuse the sensor information and basic information about the robot's motion and planned movements, in 210, to detect and track objects within the environment that may be relevant to the robot's motion and planned movements.

The safety management/robot management subsystems may, in 220, based on the tracked objects and the robot's motion, determine a safety area (e.g., a safety envelope) for the robot in the next time period, where the safety area defines an area around the robot that, to ensure safety, should remain free of objects. The safety management/robot management subsystems may receive updated robot parameters 225 that relate to the updated state of the robot with respect to the robot's load. For example, the updated robot parameters 225 may include changes in the status of the robot's load (e.g., size, weight, orientation, attachment point, distribution, stability, composition, etc.), as well as the robot's pose (e.g., position of the robotic arm, joint configurations of the robot arm, orientation of the manipulator, etc.) associated with holding the load.

As should be appreciated, and as discussed above with respect to FIGS. 1A-1C, the dynamic status of the load of the robot may be important to determining the safety envelope in 220. For example, the mass of the load may impact the overall mass of the robot, which the robot safety system 200 may use to calculate, as examples, the friction force of the robot's wheels on a given surface or the centrifugal force experienced by the robot during a turn (e.g., each of the friction force and the centrifugal force, for example, change in proportion to the overall mass of the robot). As another example, the mounting point, the shape of the robot's load, and the pose/position of the robot's arms may impact the overall dimensions of the robot. For example, the overall size of a loaded robot may be significantly wider or taller than an unloaded robot. As such, the robot safety system 200 may take these types of dynamic states of the robot's load into account when determining the robot's safety envelope. Thus, the safety envelope may be based on, as examples, a threshold breaking distance of the robot while holding the load, a threshold turn radius of the robot while holding the load, a velocity of the planned movement of the robot while holding the load, a trajectory of the planned movement of the robot while holding the load, and/or an acceleration of the planned movement of the robot while holding the load.

Next, in 220, the robot safety system 200 may fine-tune the calculated safety envelope for the robot and the other tracked objects, based on a machine-learning model of, for example, predicted trajectories. For example, the machine-learning model may contain historical information for objects and their associated trajectories, where weighted observations about the objects may be indicative of a predicted trajectory. The robot safety system 200 may, for example, compare the actual observations with the weighted observations in the machine learning model to improve the trajectory modeling and therefore the safety envelope. A machine-learning model may be particularly helpful with respect to predicting trajectories of humans that may be within the robot's environment. While human motion is unpredictable and therefore difficult to model, the human motion within a collaborative work environment may be more easily predicted. For example, in a warehouse environment, a human warehouse worker may be transporting large pallets of goods from one area to the next. When engaged in such tasks, the human worker may be pushing or pulling a heavy cart, which means that associated motions are less erratic (e.g., the human has reduced agility due to the weight of the cart, which dampens acceleration, turns, and other motions) and may be more easily modeled in the machine-learning model. In addition, many environments have well-defined pathways that direct where humans should move through the facility or to discrete loading/unloading zones, which means that a human's predicted trajectory in such environments may be more easily modeled in the learning model, where the learning model may be able to utilize positioning data and a map of the facility to improve trajectory predictions.

Once the robot safety system 200 has fine-tuned the safety envelope and predicted trajectories, it may determine, in 240, potential collision risks between the robot and the other objects in the near future (e.g., a likelihood that a tracked object may penetrate the robot's safety envelope). The robot safety system 200's identification of potential collision risks may include, for example, estimating breaking distances of the robot and objects to determine potential collision areas. The robot safety system 200 may identify, in 245, whether any of the determined potential risks exceed a predefined threshold level of safety. If so, the robot safety system 200 may determine, in 250, mitigating action(s) to address (e.g., individually and/or collectively) each potential risk that exceeded the predefined threshold safety level. For example, the mitigating action (e.g., a corrective action) may include an instruction for the robot to stop, change speed, change direction, adjust the position of the load, adjust the joint configuration, etc. so as to reduce the potential for a collision. Then, in 255, the robot safety system 200 may transmit (e.g., via a transmitter) the instruction to the robot for implementing the mitigating action(s).

During this time, the robot may have been executing its normal activities (e.g., operating according to a planned task, predefined work plan, and/or mission, and it may monitor, in 260, for incoming messages from the safety management/robot management subsystems, such as instruction with the mitigating action(s) discussed above with respect to module 250. If the robot determines that it has received a relevant instruction with the mitigating action, the robot may follow the instruction to implement the mitigating action(s). If the instructions indicate that the robot should stop its motion or pause the planned task, the robot may then wait, in 270, for a subsequent message from the robot safety system 200 instructing it to continue its normal work plan.

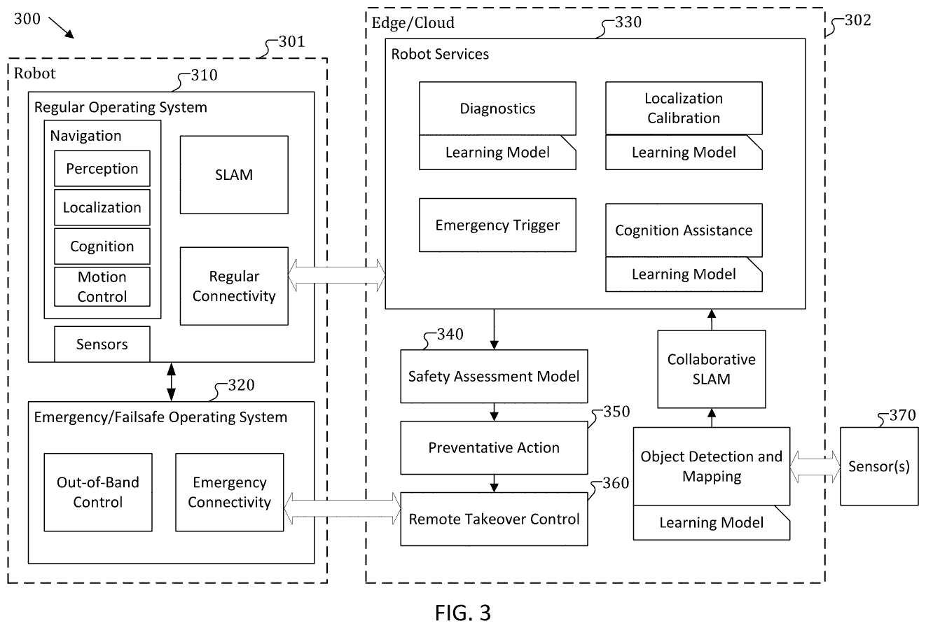

FIG. 3 shows an exemplary high-level diagram of a robot safety service system 300 for providing diagnostic assistance, localization calibration, cognition assistance, emergency assistance and/or out-of-band control for a robot. Robot safety service system 300 may include any of the features discussed above with respect to robot safety system 200. Robot safety service system 300 may be implemented as a device with a processor that is configured to operate as described herein. The device may operate as part of a server that is remote to the robot (e.g., on an edge- or cloud-based server), may be integrated into the robot, and/or may have processing/sensors that are distributed across various locations. While FIG. 3 shows one implementation where various subsystems may be located on an edge/cloud-based server 302 (e.g., those that are grouped within the frame labeled 302) and other subsystems may be located on the robot 301 (e.g., those that are grouped within frame labeled 301), this representation is not intended to be limiting, and any of the depicted subsystems may be distributed in any manner across various locations. As should be appreciated, the robot safety service system 300 may also include a receiver, transmitter, and/or transceiver for communicating information among the various processing locations (e.g., between the edge and the robot, between a sensor and the edge, between one robot and another robot, etc.). In addition, the robot safety service system 300 may store in a memory any of the data associated with any of the features below, including, as examples, robot sensor data, infrastructure sensor data, and/or navigation plan(s).

As shown in FIG. 3, robot 301 may include a regular operating system 310 for autonomous operations, such as navigation. In order to navigate, robot 301 may use perception, localization, cognition, and/or motion control algorithms to survey the environment, pinpoint the robot 301's location with respect to a map, optimize a route/task, and then make movements according to the route/task. Robot 301 may also perform simultaneous localization and motion (SLAM) algorithm to assist in navigational decisions. Robot 301 may communicate via regular communication channels with systems remote to the robot 301 (e.g., with edge/cloud-based server 302) and/or remote sensors (e.g., sensor(s) 370)). Robot 301 may also include an emergency/failsafe operating system 320 that systems external to the robot 301 may utilize for emergency control of the robot 301 and for communications with robot 301 that may occur outside of the regular communications channels.

Robot 301 may request services from other systems, include from systems that may be remote to the robot 301, e.g., on an edge/cloud-based server 302. As shown in FIG. 3, the edge/cloud-based server 302 may offer any number of on-demand robot services 330 to the robot 301, including, for example, diagnostic services, localization calibration services, cognition assistance services, and an emergency trigger. As will be discussed in more detail below, these on-demand robot services may be utilized by safety assessment model 340 for assessing the associated risk and for responding to service requests from robot 301. Based on the safety assessment model 340, the edge/cloud-base server 302 may also recommend a preventative action 350 for the robot 301 that may address a potential safety issue associated with the robot 301's request to the edge/cloud-based server 302. In addition, the edge/cloud-base server 302 may initiate a remote takeover control 360 of the robot 301 if, for example, the preventative action 350 fails to address the potential safety issue or if observations of the robot 301 indicate that the robot 401 has not implemented (e.g., partially or fully) the preventative action 350.

As with the robot safety system 200, robot safety service system 300 may receive sensor information from sensor(s) 370 that monitor the environment (e.g., the robot, the human, and/or other objects in or near the robot). Such sensors may include, as examples, a depth sensor, a camera, a radar, a light ranging and detection (LiDAR) sensor, a motion sensor, a gyroscopic sensor, an accelerometer, and/or an ultrasonic senor. As should be appreciated, the robot safety system 200 may use any type and number of sensors, and the sensor may be on the robot, remote to the robot, part of the infrastructure, and/or distributed among any number of sensors and any number of sensing locations. Robot safety service system 300 may fuse sensor data from sensor(s) 370 in order to perform object detection, object tracking, mapping, etc. for the environment, which may also feed into a simultaneous localization and motion (SLAM) algorithm, all of which (e.g., sensor data, SLAM information, object information, etc.) may be used by on-demand robot services 330.

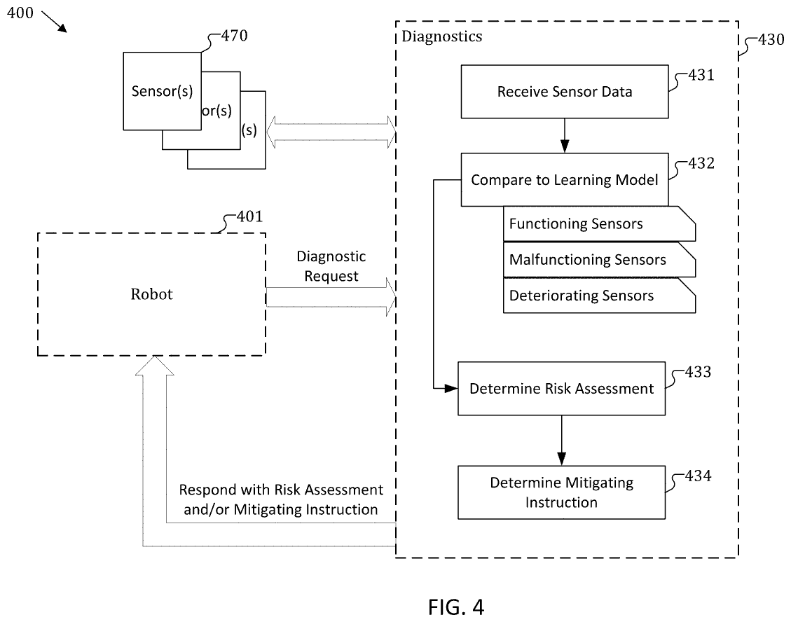

FIG. 4 is an exemplary flow diagram 400 for diagnostic services that may be provided to a robot (e.g., robot 401) by a robot safety service system (e.g., robot safety service system 300 as part of on-demand robot services 330 discussed above with respect to FIG. 3). For example, diagnostic services module 430 may receive a request from robot 401 in order to diagnose sensor data. In order to respond to the request, the diagnostic services module 430 may receive sensor data from any number of sensor(s) 470. As with sensor(s) 370, the sensor(s) 470 may be of any type and number, and the sensor(s) may be on the robot, remote to the robot, part of the infrastructure, and/or distributed among any number of sensors and any number of sensing locations. The diagnostic services module 430 may use a machine learning model to analyze the received sensor data, where the machine learning model may be a trained dataset of sensor data that is associated with sensor data for functioning sensors, malfunctioning sensors, deteriorating sensors, mis-calibrated sensors, etc.

Based on received sensor data and the machine learning model, the diagnostic services module 430 may determine, in 432, the reliability of the sensor data (e.g., which sensor data is from a functioning sensor versus which sensor data is from a malfunctioning or deteriorating sensors). The diagnostic services module 430 may provide the reliability information about each sensor to determine, in 433, a risk assessment that may take into account the sensor reliability information for each sensor. In addition, the diagnostic services module 430 may also take into account the extent of the unreliability, the type of sensor (e.g., whether it is correctable (e.g., with a calibration or reset) or non-correctable), the risk severity associated with sensor data on the processing algorithm (e.g., incorrect sensor data for an impact sensor may have a low severity for navigational processing whereas incorrect sensor data for a positioning sensor may have a high severity for navigational processing), etc. Based on the determined risk assessment, the diagnostic services module 430 may generate a mitigating instruction 434 for robot 401, which may be communicated to the robot 401 for execution. For example, the mitigating instruction 434 may instruct the robot 401 to stop using certain sensor data; to weight certain sensor data with a higher/lower level of importance in its internal processing; to reset certain sensors; to recalibrate certain sensors; and/or to stop certain movements, stop all operations, and/or move to a safe location.

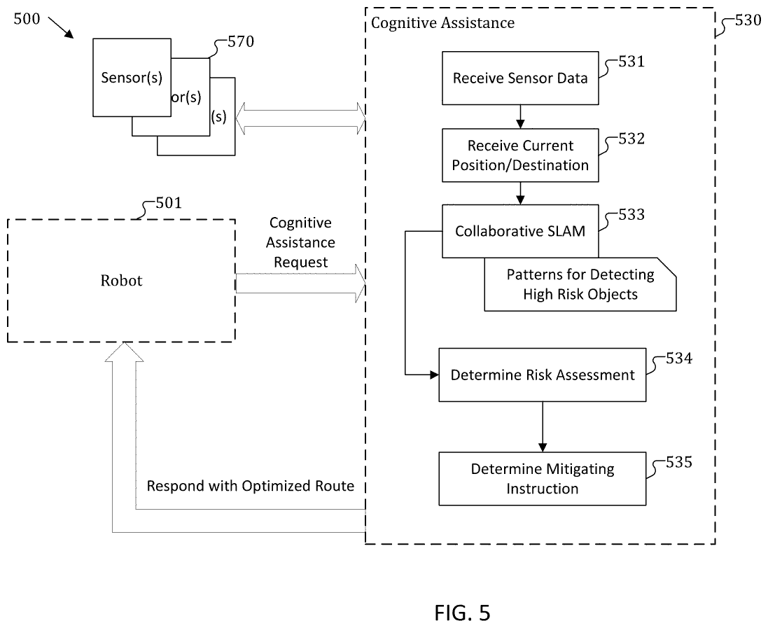

FIG. 5 is an exemplary flow diagram 500 for cognitive assistance services that may be provided to a robot (e.g., robot 501) by a robot safety service system (e.g., robot safety service system 300 as part of on-demand robot services 330 discussed above with respect to FIG. 3). For example, cognitive assistance services module 530 may receive a request from robot 501 for cognitive assistance. Cognitive assistance, as used herein, may be understood as processing assistance to analyze data and/or make determinations based on data. For example, a robot may, due to size and cost, have minimal on-board processing capabilities, and the robot may not have sufficient on-board processing capabilities to perform complex analysis (e.g., process camera images for SLAM processing, fuse sensor data from several sources to optimize a navigational route, etc.) on large amounts of data, and a robot may wish to offload the processing to a cloud-based server that offers such cognitive assistance (e.g., such as cognitive assistance services module 530).

To respond to a request for cognitive assistance from robot 501, the cognitive assistance services module 530 may receive, in 531, sensor data from any number of sensor(s) 570. As with sensor(s) 370 and 470, the sensor(s) 570 may be of any type and number, and the sensor(s) may be on the robot, remote to the robot, part of the infrastructure, and/or distributed among any number of sensors and any number of sensing locations. As part of the sensor data or as a separate communication from the robot 501 or other planning system, the cognitive assistance services module 530 may receive, in 532, the current position, trajectory, destination, or other information about the planned movements of robot 501. The cognitive assistance services module 530 may analyze, in 533, the sensor data and/or planned movement information with a machine learning model to match current sensor data and planned movement information with historical/trained data in the machine learning model. For example, the machine learning model may be a trained dataset of sensor data that is associated with object detection, object tracking, and/or other SLAM-related analysis that may be sourced from numerous robots and numerous sensors.

Based on received sensor data and the machine learning model, the cognitive assistance services module 530 may determine, in 533, the expected position and/or trajectory of high risks objects that may impact the planned movements of robot 501. For example, the high risk objects may include high risk pedestrians (e.g., disabled persons; elderly persons that walk with a cane, walker, or other type of assistance; pregnant women; running children; and/or crawling toddlers) that may be within the robot's planned path, large crowds that may obstruct the path of robot 501 or may lead to the robot 501 being trapped within the crowd, or other large objects/obstructions that block the passageway of robot 501 and around which the robot 501 alone may not be able to navigate.

The cognitive assistance services module 530 may then analyze the determined position/trajectory information about high risk objects, along with the sensor data and any SLAM-related analysis, to determine, in 534, a risk assessment for the robot 501 related to the these high-risk objects for planning an optimum navigation route to its destination that may minimize the risk for the robot 501 with respect to detected high risk objects. Based on the determined risk assessment, the cognitive assistance services module 530 may generate a mitigating instruction 535 for robot 501, which may be communicated to the robot 501 for execution. For example, the mitigating instruction 535 may instruct the robot 501 to utilize an optimized route, trajectory, and/or particular motions to navigate to its destination.

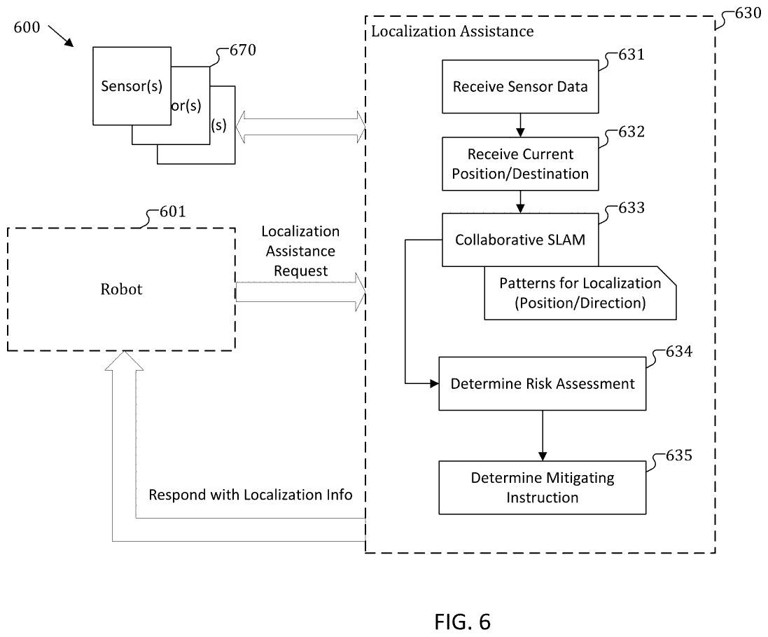

FIG. 6 is an exemplary flow diagram 600 for localization assistance that may be provided to a robot (e.g., robot 601) by a robot safety service system (e.g., robot safety service system 300 as part of on-demand robot services 330 discussed above with respect to FIG. 3). For example, localization assistance module 630 may receive a request from robot 601 for localization assistance after robot 601 crashes, loses its position, is unexpectedly stopped by a blockage in its path, and/or the robot 601 is unable to sufficiently scan the environment to adequately determine its location. To respond to a request for localization assistance from robot 601, the localization assistance module 630 may receive, in 631, sensor data from any number of sensor(s) 670. As with sensor(s) 370, 470, and 570, the sensor(s) 670 may be of any type and number, and the sensor(s) 670 may be on the robot, remote to the robot, part of the infrastructure, and/or distributed among any number of sensors and any number of sensing locations. As part of the sensor data or as a separate communication from the robot 601 or other planning system, the localization assistance module 630 may receive, in 632, the last known position, trajectory, destination, or other information about the previous and/or planned movements of robot 601. The localization assistance module 630 may analyze, in 633, the sensor data and/or previous/planned movement information with a machine learning model to match current sensor data and previous/planned movement information with historical/trained data in the machine learning model. For example, the machine learning model may be a trained dataset of sensor data that is associated with localization, positioning, trajectory planning, and other SLAM-related analysis that may be sourced from numerous robots and numerous sensors.

Based on received sensor data and the machine learning model, the localization assistance module 630 may determine the position and/or trajectory of robot 601. The localization assistance module 630 may then provide the position and trajectory information, along with the sensor data and any SLAM-related analysis, to determine, in 634, a risk assessment for the robot 601 with respect to nearby objects at the current position. Based on the determined risk assessment, the localization assistance module 630 may generate a mitigating instruction 635 for robot 601, which may be communicated to the robot 601 for execution. For example, the mitigating instruction 635 may instruct the robot 601 to utilize an optimized route, trajectory, and/or motions to navigate to its destination.

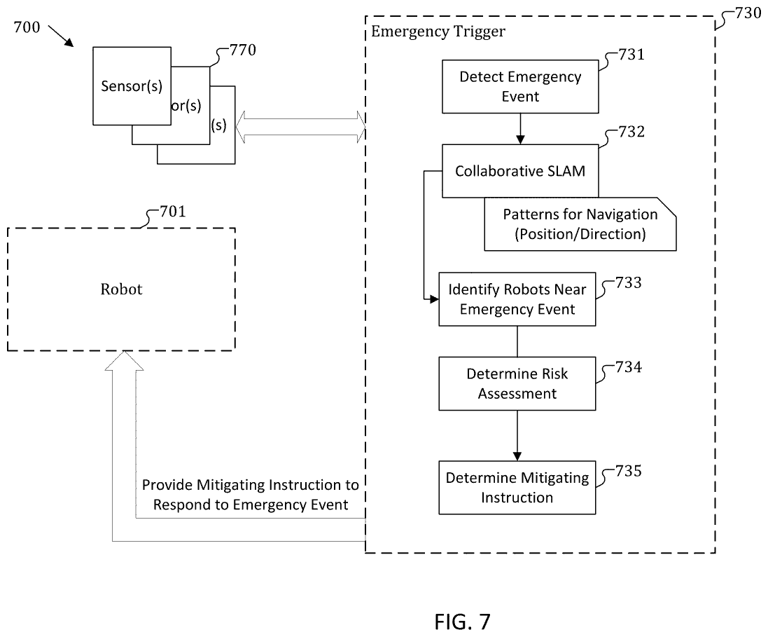

FIG. 7 is an exemplary flow diagram 700 for an emergency trigger service that may be provided to a robot (e.g., robot 701) by a robot safety service system (e.g., robot safety service system 300 as part of on-demand robot services 330 discussed above with respect to FIG. 3). For example, emergency trigger module 730 may detect an indication that an emergency may be occurring or may be imminent that may impact a robot's environment (e.g., a fire alarm, a tornado warning, an earthquake alarm, etc.). The emergency trigger module 730 may determine the emergency from sensor data and/or from a received message (e.g., from an emergency weather service, national weather center, etc.). The emergency trigger module 730 may receive the sensor data/message from any number of sensor(s) 770. As with sensor(s) 370, 470, 570, and 670, the sensor(s) 770 may be of any type and number, and the sensor(s) may be on the robot, remote to the robot, part of the infrastructure, and/or distributed among any number of sensors and any number of sensing locations.

As part of the sensor data or as a separate communication from robot 701, from other robots, or from a central planning system, the emergency trigger module 730 may determine and/or receive the current positions of robots. The emergency trigger module 730 may analyze, in 732, the sensor data and/or robot location information with a machine learning model to match current sensor data and location information with historical/trained data in the machine learning model. For example, the machine learning model may be a trained dataset of sensor data that is associated with localization, positioning, trajectory planning, and other SLAM-related analysis that may be sourced from numerous robots and numerous sensors.

Based on the current positions of the robots and the machine learning model, the emergency trigger module 730 may identify, in 733, robots that may be impacted by the emergency event, and, in 734, determine a risk assessment for each robot with respect to the emergency event. For example, emergency trigger module 730 may determine that robot 701 is blocking an emergency exit during a fire alarm event. Based on the risk assessment, the emergency trigger module 730 may determine, in 735, a mitigating instruction for robots that may be impacted by the emergency event. For example, if robot 701 is blocking an emergency exit, the mitigating instruction 735 may instruct robot 701 to navigate to a new location and/or stop its planned movements.

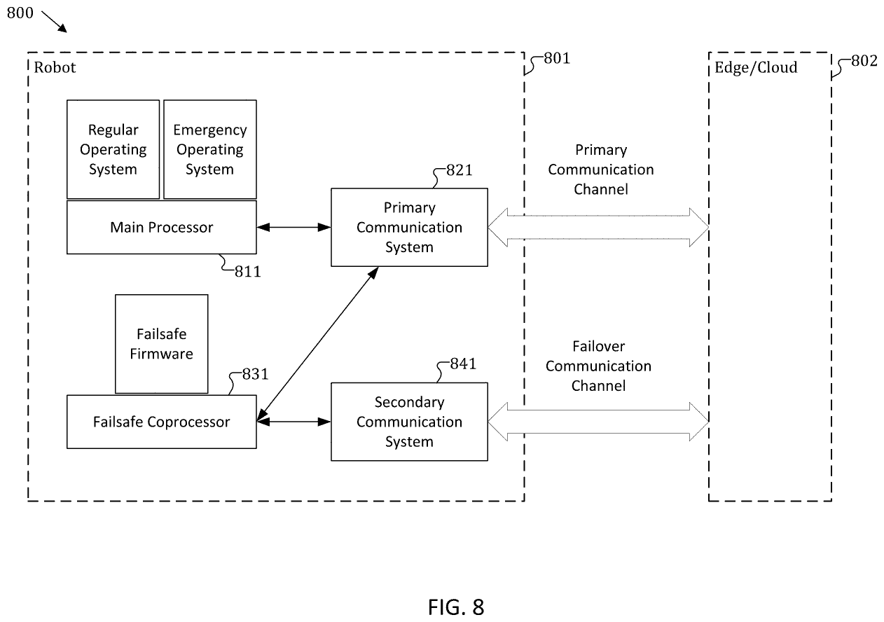

FIG. 8 is an exemplary flow diagram 800 that shows a remote takeover control that may be utilized by a robot safety service system (e.g., remote takeover control 360 discussed above with respect to FIG. 3) to remotely take control of a robot (e.g., robot 801). Robot 801 may divide its processing and/or communications systems into two parts: (1) a primary processing part that may be associated with a main processor (e.g., main processor 811) and a primary communication system (e.g., primary communication system 821) and (2) a failsafe processing part that may associated with a failsafe processor (e.g., failsafe coprocessor 831) and a secondary communication system (e.g., secondary communication system 841). The two parts may be realized using physically separate components, logically separated structures on the same physical components, or a combination of either. The primary processing part may include a main processor 811 that may be used, for example, to run a regular operating system that may process movement instructions, operate its motor controls, perform basic sensor processing, etc. as part of its regular tasks. Robot 801 may use its primary communication system 821 (e.g., a receiver, a transmitter, or a transceiver) for communicating messages with systems that may be remote to robot 801 (e.g., to infrastructure systems, other robots, an edge-/cloud-based server (e.g., edge/cloud-based server 802), etc.). For example, robot 801 may use the primary communication system 821 to receive sensor data from any number of sensors, receive instructions/messages from the edge/cloud-based server 802, send requests to on-demand processing services on the edge/cloud-based server 802, etc. during normal operations of the robot 801.

The failsafe processing part may be understood as failsafe system that may be accessed when the primary processing part is not responding or appears to be unreliable. For example, as part of the failsafe processing part, robot 801 may have a failsafe coprocessor 831 that may operate independently from the main processor 811. In addition, robot 801 may also have a secondary communication system 841 that may operate independently from and may use a different communication channel from the primary communication system 821 (e.g., different hardware, different communication protocols, different frequency ranges, different timeslots, etc.). The failsafe processing part may be understood as providing “out-of-band” (OOB) support, where external systems may be able to use the OOB support to perform remote diagnostics, remote recovery actions, and remote control when the primary processing part is not responding or appears to be unreliable. For example, the robot 801 may experience a software fault in its primary processing part, a hardware failure associated with its primary processing part (e.g., a motor failure, a sensor failure, etc.), and/or external factors that impede primary processing and communications (e.g., a disruption, signal loss, or jamming of the communication network (e.g., Wi-Fi) used by the primary communication system) and which may cause the robot to deviate from its planned movements or fail to response to an instruction.

In such circumstances, an external system (e.g., edge/cloud-based server 802) may utilize OOB support to regain control of the robot and prevent the robot from causing a harmful situation. Referring to FIG. 8, for example, edge/cloud-based server 802 may detect that robot 801 is deviating from its planned navigation course and has not followed mitigating instructions sent by the edge/cloud-based server 802 over the primary communication channel to correct the deviation. The edge/cloud-based server 802 may attempt to communicate with the failsafe processing of robot 801 over a failover communication channel. The failsafe processing on robot 801 may utilize a failsafe coprocessor 831 with failsafe firmware that may be partially or fully isolated from main processor 811 such that the failsafe firmware may still respond to OOB communications (e.g., using secondary communication system 841).

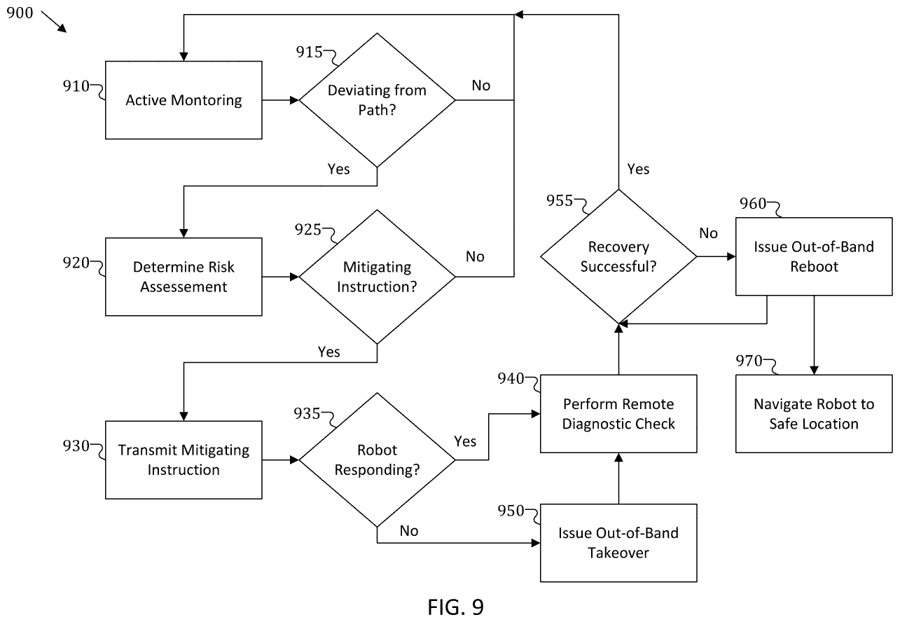

FIG. 9 shows an exemplary flow diagram 900 for a monitoring service that may be provided to a robot (e.g., robot 701) by a robot safety service system (e.g., robot safety service system 300 discussed above with respect to FIG. 3). The monitoring service may act as a system-wide intelligence for coordinating safe movements within the environment (e.g., acting as an “air traffic controller” that actively monitors and coordinates the location of one or more robots in an environment. For example, as shown flow diagram 900 of FIG. 9, a robot safety service system may, in 910, actively monitor an environment that may contain one or more robots. To do so, the robot safety service system may use sensor data from any number of sensor(s) or sources that may be from the robot(s), remote to the robot(s), part of the infrastructure, and/or distributed among any number of sensors/sources and any number of sensing locations. As should be appreciated, the robot safety service system associated with flow diagram 900 may operate on a server that is remote to the robot (e.g., on an edge- or cloud-based server), may be integrated into the robot, and/or may have processing/sensors that are distributed across various locations.

While monitoring the environment, the robot safety service system may determine, in 915, that a robot is deviating from its planned trajectory, planned motion, or other planned tasks. If so, the robot safety service system may assess, in 920, the safety impact of the deviation and determine a risk assessment associated with the deviation. The risk assessment may include a consideration of the safety of other objects (e.g., humans) within the environment, the safety of other robots within the environment, or other hazards that the robot may encounter as a result of the deviation. In 925, the robot safety service system may determine, based on the risk assessment (e.g., whether the risk assessment exceeds a predetermined threshold), whether a mitigating instruction is necessary. If so, the robot safety service system may transmit, in 930, the mitigating instruction to the deviating robot (e.g., over a primary communication channel as described above with respect to FIG. 8). After transmitting the mitigating instruction, the robot safety service system may continue to monitor the robot with updated information and determine, in 935, if the robot has successfully implemented the mitigating instruction (e.g., the robot has returned to its planned trajectory).

If so, the robot safety service system may perform, in 940, a diagnostic check on the robot (e.g., using diagnostic services module 430 described above with respect to FIG. 4) to confirm that the reliability of the sensors. Otherwise, if the robot has failed to implement the mitigating instruction, the robot safety service system may issue, in 950, an out-of-band takeover command (e.g., over a failover communication channel as described above with respect to FIG. 8) and may also perform, in 940, a diagnostic check on the robot to identify potential faults in the primary processing system (e.g., primary processing associated with main processor 811 and primary communication system 821 described above with respect to FIG. 8). Next, the robot safety service system may assess, in 955, whether the out-of-band takeover command was successful in restoring the primary processing system. If not, the robot safety service system may issue, in 960, an out-of-band reboot instruction (e.g., over a failover communication channel as described above with respect to FIG. 8) until the robot safety service system is able to, in 970, regain control of the robot and/or navigate the robot to a safe location.

As should be apparent from the robot safety systems described above, such a robot safety system (e.g., robot safety system 200) may be implemented as part of a server that is remote to the robot (e.g., on an edge- or cloud-based server), may be integrated into the robot, and/or may have processing/sensors that are distributed across various locations. As such, it may be important to monitor the overall integrity of the robot safety system, especially where the distributed nature of the system may introduce a number of additional potential failure points. To ensure safe operation, a robot safety system may employ an integrity-checking system to monitor that each of its subsystems are functioning correctly, which may include the processing pipeline and communications among the various subsystems that may support it.

A common way to ensure that all subsystems are working properly is for an integrity-checking system to use redundancy. The simplest case is double redundancy, where the subsystem includes a redundant counterpart of a given component, and the integrity-checking system compares the output of the component with the output of its redundant counterpart. If there is a mismatch, the integrity-checking system may determine that a failure has occurred. For sensor processing, duplicate processing pipelines (e.g., redundant sensor hardware, redundant sensor fusion processing, redundant communications paths, etc.) may be added, where the integrity-checking system then compares the outputs of both pipelines and identifies data differences to detect failures. Redundancy, however, may require adding numerous components to the overall robot system, and it is therefore an expensive way of detecting failures. In addition, redundancy may not be able to detect errors in cases where the robot has stopped moving, the communication pipeline is frozen, the mechanical actuators of the robot have jammed, the robot's motion is repetitive, or if a malicious attacker has infiltrated the redundancy system to fabricate a match. Each of these potential problems may be a significant weakness in integrity-checking systems based on redundancy.

By contrast to redundancy, the integrity-checking system described below may provide for system integrity checking without the need for redundancy and its associated added costs. The disclosed integrity-checking system may track the location of a robot and compare the expected location of the robot with a camera image at the expected location. If the robot does not appear in the camera image as expected, the disclosed integrity-checking system may detect possible faults in any of a number of subsystems within the overall robot safety system. Advantageously, such integrity checking may schedule checks to occur by time, task, use case, environment, etc., depending on the safety needs of the environment. In addition, by removing the need for redundancy, the disclosed integrity-checking system may have a reduced number of components (and associated costs). In addition, the disclosed integrity-checking system may be able to monitor any of a number of subsystems within the overall robot safety system (e.g., sensor hardware, sensor processing, motion control, mechanical actuators on the robot, the communication channels for transmitting information among the locations of the distributed system, etc.) rather than just discrete portions, as would be the case with a redundancy-based system. As such, a single integrity check may check a larger portion of the robot's system.

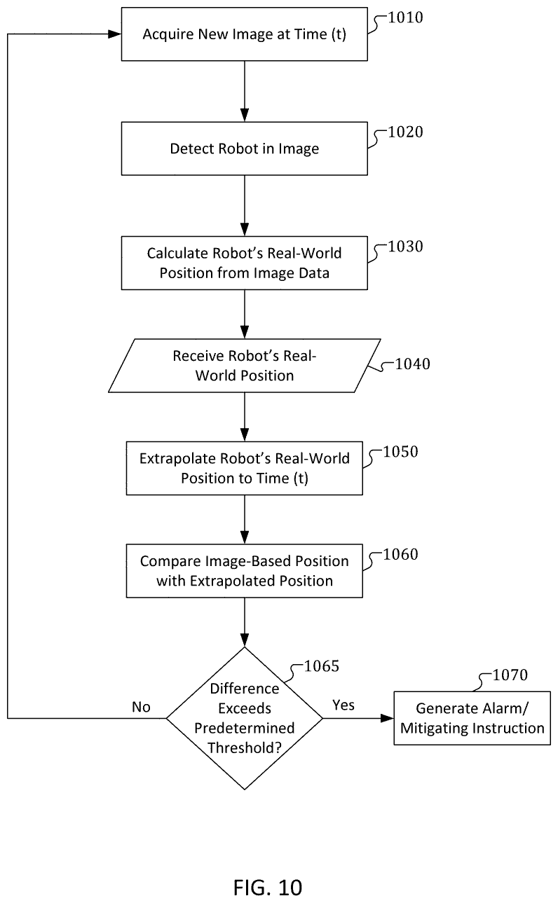

FIG. 10 shows an exemplary flow diagram for an integrity-checking system 1000 that may be provided as part of a robot safety service system (e.g., robot safety service system 300 discussed above with respect to FIG. 3) and/or robot safety system 200. It should be appreciated that FIG. 10 is merely exemplary and is not intended to limit robot safety service system 300 and/or robot safety system 200, which may be implemented in any number of ways and may have any or none of the aspects discussed below with respect to flow diagram 1000. The integrity-checking system 1000 shown in FIG. 10 may be implemented as a device with a processor that is configured to operate as described below, and the device may operate as part of a server that is remote to the robot (e.g., on an edge- or cloud-based server), may be integrated into the robot, and/or may have processing/sensors that are distributed across various locations. The integrity-checking system 1000 may also include a receiver, transmitter, and/or transceiver for communicating information among the various processing locations (e.g., between the edge and the robot, between a sensor and the edge, between one robot and another robot, etc.). In addition, the integrity-checking system 1000 discussed below may store (e.g., in a memory) any data associated with any of the features below, including, as examples, the projected location, the measurement time, the received images, the diagnostic alarm, and/or the predetermined threshold value.

The integrity-checking system 1000 may begin an integrity check by, in 1010, acquiring a new image that was captured at a given time (e.g., time t). The integrity-checking system 1000 may receive the image data (e.g., via a receiver) from a camera or cameras that are located, for example, at fixed infrastructure locations throughout the environment in which a robot may be operating. Using the acquired image data, the integrity-checking system 1000 may detect that a robot is located within the image. Using the known (e.g., fixed) location of the camera or cameras that captured the image data, the integrity-checking system 1000 may calculate, in 1030, a position of the located robot from the camera data by projecting the image data onto a ground plane of a common coordinate system associated with the known locations of the camera or cameras. In this sense, the calculated position may be, for example, translated into a common coordinate system (e.g., a world coordinate system).

The integrity-checking system 1000 may also receive, in 1040, an actual position of the detected robot that indicates, for example, the last known world position of the robot at a given point in time. The integrity-checking system 1000 may receive the actual position from the robot itself, from sensor data about the robot, and/or from a central planning system that is monitoring the robot's movements. Next, the integrity-checking system 1000 may extrapolate, in 1050, the received actual position of the robot to the time at which the camera captured the image (e.g., time t) using known techniques for trajectory prediction. The integrity-checking system 1000 may then compare, in 1060, the extrapolated position of the robot (e.g., determined from the received actual position of the robot) to the calculated position of the robot (e.g., determined from the camera data). If the position difference exceeds, in 1065, a predetermined threshold, the integrity-checking system 1000 may generate, in 1070, a diagnostic alarm and/or mitigating instructions for the robot, otherwise the integrity-checking system 1000 may repeat its integrity check by acquiring a new image at a new time. The diagnostic alarm and/or mitigating instruction may be an indication for the robot system to perform a calibration, an indication for the robot system to perform a measurement, a indication of a perception malfunction of the robot system associated with the received images, an indication of a motor malfunction of a motor on the robot, indication of a motion control malfunction of the robot system, or an indication of a communication malfunction of communications between the robot and other parts of the robot system. As should be appreciated, the integrity-checking system 1000 may use any number of predefined thresholds, each of which may be associated with generating a different type of diagnostic alarm and/or mitigating instruction to more finely tune the integrity-checking system 1000 and to allow the robot safety service system to detect/correct errors before a critical safety event may occur.

The integrity-checking system 1000 may also detect unexpected/unsafe latencies within the overall robot system. For example, the position difference between the extrapolated position of the robot (e.g., determined from the received actual position of the robot) and the calculated position of the robot (e.g., determined from the camera data) may be divided by the speed of the robot. As should also be appreciated, the integrity-checking system 1000 may fuse any available sensor data to improve the determination of the extrapolated position (e.g., using a friction coefficient to account for slippage, using GPS data to improve position accuracy, using accelerometer data to account for directional speed changes, etc.).

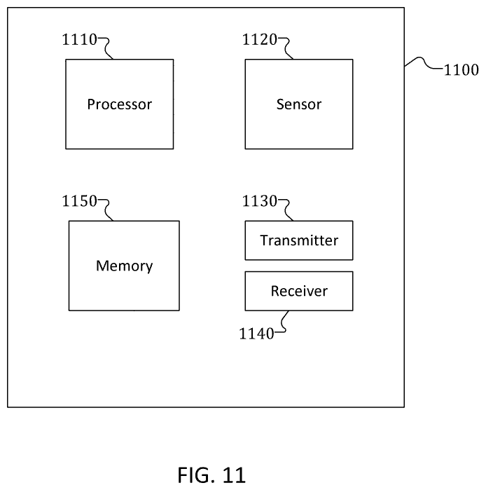

FIG. 11 is a schematic drawing illustrating a device 1100 for improving robot safety. The device 1100 may include any of the features discussed above with respect to robot safety system 200, robot safety service system 300, integrity-checking system 1000, and/or FIGS. 1-10. FIG. 11 may be implemented as a device, a system, a method, and/or a computer readable medium that, when executed, performs the features of the robot safety systems described above. It should be understood that device 1100 is only an example, and other configurations may be possible that include, for example, different components or additional components.

Device 1100 includes a processor 1110 that is configured to determine a safety envelope of a robot based on a planned movement of the robot and based on state information about a load carried by a robot, wherein the state information includes a dynamic status of the load. In addition to or in combination with any of the features described in this or the following paragraphs, processor 1100 is also configured to determine a safety risk based on a detected object with respect to the safety envelope. In addition to or in combination with any of the features described in this or the following paragraphs, processor 1110 is also configured to generate a mitigating action to the planned movement if the safety risk exceeds a threshold value.

Furthermore, in addition to or in combination with any one of the features of this and/or the preceding paragraph, the dynamic status of the load may include changes in at least one of a mass of the load, a shape of the load, a height of the load, a width of the load, a volume of the load, a mounting point of the load on the robot, or a distance of the load from a center of gravity of the robot. Furthermore, in addition to or in combination with any one of the features of this and/or the preceding paragraph, the planned movement of the robot may include at least one of a movement of the robot along a planned trajectory, a velocity of the movement of the robot along the planned trajectory, or a position of the robot along the planned trajectory. Furthermore, in addition to or in combination with any one of the features of this and/or the preceding paragraph, processor 1110 may be configured to determine the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

Furthermore, in addition to or in combination with any one of the features of this and/or the preceding two paragraphs, processor 1110 may be configured to determine a predicted trajectory of the detected object based on at least one of past trajectories of other objects similar to the detected object, a velocity of the detected object, an acceleration of the detected object, a type of detected object, or a pose of the detected object. Furthermore, in addition to or in combination with any one of the features of this and/or the preceding two paragraphs, processor 1110 may be configured to receive the past trajectories from a machine learning model associated with the other objects. Furthermore, in addition to or in combination with any one of the features of this and/or the preceding two paragraphs, processor 1110 may be configured to receive the state information from a sensor 1120 configured to collect sensor data indicative of the state information. Furthermore, in addition to or in combination with any one of the features of this and/or the preceding two paragraphs, processor 1110 may be configured to receive the state information from sensor 1120 via receiver 1130. Furthermore, in addition to or in combination with any one of the features of this and/or the preceding two paragraphs, the device 1100 may include sensor 1120.

Furthermore, in addition to or in combination with any one of the features of this and/or the preceding three paragraphs, device 1100 may further include a memory 1150 that may be configured to store at least one of the safety envelope, the safety risk, or the mitigating action. Furthermore, in addition to or in combination with any one of the features of this and/or the preceding three paragraphs, the robot may be remote from device 1100.

In other aspects, device 1100 includes a processor 1110 configured to determine a reliability level of a sensor 1120 of a robot based on a difference between sensor data indicative of a current motion of the robot in an environment and expected sensor data for the environment and the current motion. In addition to or in combination with any of the features described in this or the following paragraphs, processor 1110 is also configured to determine a risk assessment based on the reliability level of sensor 1120 and based on an expected movement of the robot. In addition to or in combination with any of the features described in this or the following paragraphs, processor 1110 is also configured to generate a mitigation plan for the robot if the risk assessment exceeds a threshold value.

Furthermore, in addition to or in combination with any one of the features of this and/or the preceding paragraph, the mitigation plan may include an instruction for the robot to calibrate the sensor 1120. Furthermore, in addition to or in combination with any one of the features of this and/or the preceding paragraph the mitigation plan may include an instruction for the robot to modify a parameter of the expected movement. Furthermore, in addition to or in combination with any one of the features of this and/or the preceding paragraph the parameter of the expected movement may include at least one of a speed, an acceleration, a trajectory, or a target location of the robot. Furthermore, in addition to or in combination with any one of the features of this and/or the preceding paragraph, processor 1110 may be configured to receive the expected sensor data from a neural network model of trained sensor data. Furthermore, in addition to or in combination with any one of the features of this and/or the preceding paragraph, processor 1110 may be configured to determine the risk assessment based on a location of identified objects within the environment.

Furthermore, in addition to or in combination with any one of the features of this and/or the preceding two paragraphs, processor 1110 may be configured to determine the risk assessment based a magnitude of the difference between the sensor data and the expected sensor data. Furthermore, in addition to or in combination with any one of the features of this and/or the preceding two paragraphs, processor 1110 may be configured to determine the risk assessment based a safety impact of the sensor data to the expected movement of the robot. Furthermore, in addition to or in combination with any one of the features of this and/or the preceding two paragraphs, processor 1110 may be configured to determine the risk assessment based a type of sensor 1120.

In other aspects, device 1100 includes a processor 1110 configured to receive robot sensor data from a plurality of robots, wherein the robot sensor data is indicative of an operating area of the plurality of robots. In addition to or in combination with any of the features described in this or the following paragraphs, processor 1110 is also configured to receive infrastructure sensor data indicative of the operating area from an infrastructure camera in the operating area. In addition to or in combination with any of the features described in this or the following paragraphs, processor 1110 is also configured to detect an obstruction within the operating area based on the robot sensor data and based on the infrastructure data, wherein the obstruction is located between a current location of at least one robot of the plurality of robots and a target location for the at least one robot. In addition to or in combination with any of the features described in this or the following paragraphs, processor 1110 is also configured to generate a navigation plan to the target location for the at least one robot based on the obstruction and based on the current location.

Furthermore, in addition to or in combination with any one of the features of this and/or the preceding paragraph, processor 1110 may be further configured to determine the current location of the at least one robot based on a positional learning model that is compared to the infrastructure sensor data and robot sensor data. Furthermore, in addition to or in combination with any one of the features of this and/or the preceding two paragraphs, the obstruction may include a detected static object, a detected moving object, or a high risk area. Furthermore, in addition to or in combination with any one of the features of this and/or the preceding two paragraphs, processor 1110 may be configured to detect the obstruction based on an object detection learning model that is compared to the infrastructure sensor data and robot sensor data.

Furthermore, in addition to or in combination with any one of the features of this and/or the preceding two paragraphs, processor 1110 may be further configured to detect an emergency event within the environment based on the robot sensor data or based on the infrastructure data. Furthermore, in addition to or in combination with any one of the features of this and/or the preceding two paragraphs, processor 1110 may also be configured to generate an emergency plan for the at least one robot based on a risk assessment of the emergency event, wherein the emergency plan may include at least one of a revised navigation plant to the target location, a right-of-way of the at least one robot to move within the environment, or a revised target location for the at least one robot that is different from the target location. Furthermore, in addition to or in combination with any one of the features of this and/or the preceding two paragraphs, device 1100 may further include a memory 1150 configured to store at least one of the robot sensor data, the infrastructure sensor data, or the navigation plan.

In other aspects, device 1100 includes a processor 1110 configured to determine a deviation of a robot from a planned trajectory, wherein the deviation is based on a comparison of the planned trajectory with received sensor data indicative of an actual trajectory of the robot. In addition to or in combination with any of the features described in this or the following paragraphs, processor 1110 is also configured to determine a risk score associated with the deviation, wherein the risk score is based on identified objects within the actual trajectory. In addition to or in combination with any of the features described in this or the following paragraphs, processor 1110 is also configured to generate a mitigation instruction if the risk score exceeds a threshold value, wherein the mitigation instruction includes a revised trajectory for the robot. In addition to or in combination with any of the features described in this or the following paragraphs, processor 1110 is also configured to generate a takeover instruction if a difference between the revised trajectory and updated sensor data indicative of an updated actual trajectory of the robot exceeds a threshold difference.

Furthermore, in addition to or in combination with any one of the features of this and/or the preceding paragraph, device 1100 may further include a transmitter 1130 configured to transmit the mitigation instruction and the takeover instruction to the robot. Furthermore, in addition to or in combination with any one of the features of this and/or the preceding paragraph, the takeover instruction may include an indication to activate to a safety subsystem of the robot. Furthermore, in addition to or in combination with any one of the features of this and/or the preceding paragraph, the transmitter 1130 may be configured to transmit the mitigation instruction to the robot over a first communications channel, wherein the transmitter 1130 may be configured to transmit the takeover instruction to the robot over a second communications channel, wherein the first communications channel may be different from the second communications channel. Furthermore, in addition to or in combination with any one of the features of this and/or the preceding paragraph, the mitigation instruction may include a transmission request for the robot to transmit diagnostic information to device 1100. Furthermore, in addition to or in combination with any one of the features of this and/or the preceding paragraph, device 1100 may further include a memory 1150 configured to store at least one of the deviation, the risk score, the mitigation instruction, or the takeover instruction.

In other aspects, device 1100 includes a processor 1110 configured to determine a projected location of a robot at a measurement time based on received images of the robot. In addition to or in combination with any of the features described in this or the following paragraphs, processor 1110 is further configured to generate a diagnostic alarm if a reported positional location reported by the robot at the measurement time differs from the projected location by a threshold value.

Furthermore, in addition to or in combination with any one of the features of this and/or the preceding paragraph, device 1100 may further include receiver 1140, wherein processor 1110 may be configured to receive via receiver 1140 the received images from a camera that may be at a fixed location with respect to the robot. Furthermore, in addition to or in combination with any one of the features of this and/or the preceding paragraph, device 1100 may further include a receiver 1140, wherein processor 1110 may be configured to receive via receiver 1140 the reported positional location from the robot. Furthermore, in addition to or in combination with any one of the features of this and/or the preceding paragraph, the projected location may be defined with respect to a first coordinate system, wherein processor 1110 configured to determine the projected location may include processor 1110 configured to convert an image position of the robot defined with respect to a second coordinate system into the projected location based on the fixed location of the camera, wherein the first coordinate system may be different from the second coordinate system.

Furthermore, in addition to or in combination with any one of the features of this and/or the preceding two paragraphs, the first coordinate system may include a world coordinate system indicative of the robot within a world environment, wherein the second coordinate system may include an image coordinate system indicative of the robot within the received images. Furthermore, in addition to or in combination with any one of the features of this and/or the preceding two paragraphs, the fixed location may be defined with respect to the world coordinate system. Furthermore, in addition to or in combination with any one of the features of this and/or the preceding two paragraphs, device 1100 may further include a memory 1150 that may be configured to store at least one of the projected location, the measurement time, the received images, the diagnostic alarm, or the threshold value. Furthermore, in addition to or in combination with any one of the features of this and/or the preceding two paragraphs, the received images may be associated with a first timeframe that is before the measurement time, wherein processor 1110 may be configured to determine the projected location based on an estimated trajectory of the robot in the first timeframe. Furthermore, in addition to or in combination with any one of the features of this and/or the preceding two paragraphs, the diagnostic alarm may include a message indicating at least one of a request to perform a calibration, a request to perform a measurement, a perception malfunction associated with the received images, a motor malfunction of a motor on the robot, a motion control malfunction, or a communication malfunction of communications between the robot and the device 1100.

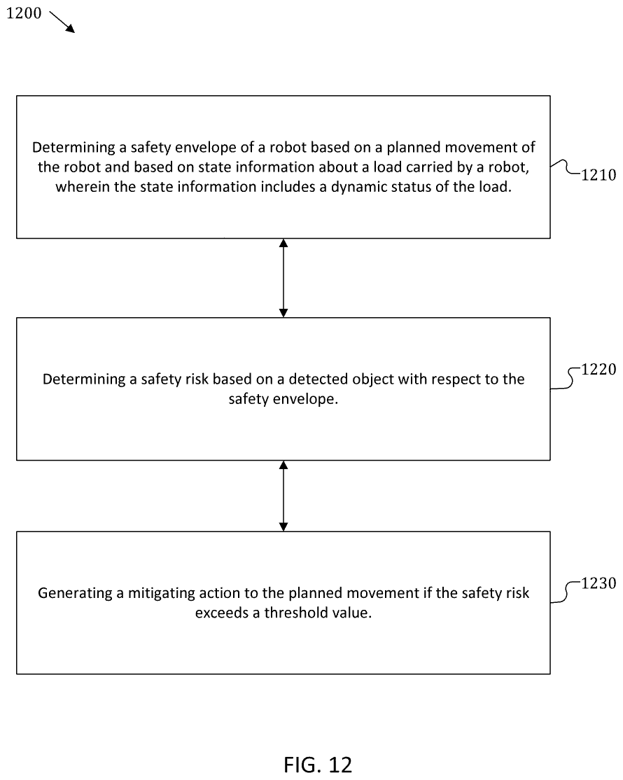

FIG. 12 depicts a schematic flow diagram of a method 1200 for improving the safety of a robot. Method 1200 may implement any of the features described above with respect to robot safety system 200, robot safety service system 300, integrity-checking system 1000, device 1100, and/or FIGS. 1-11.

Method 1200 includes, in 1210, determining a safety envelope of a robot based on a planned movement of the robot and based on state information about a load carried by a robot, wherein the state information includes a dynamic status of the load. The method also includes, in 1220, determining a safety risk based on a detected object with respect to the safety envelope. The method also includes, in 1230, generating a mitigating action to the planned movement if the safety risk exceeds a threshold value.

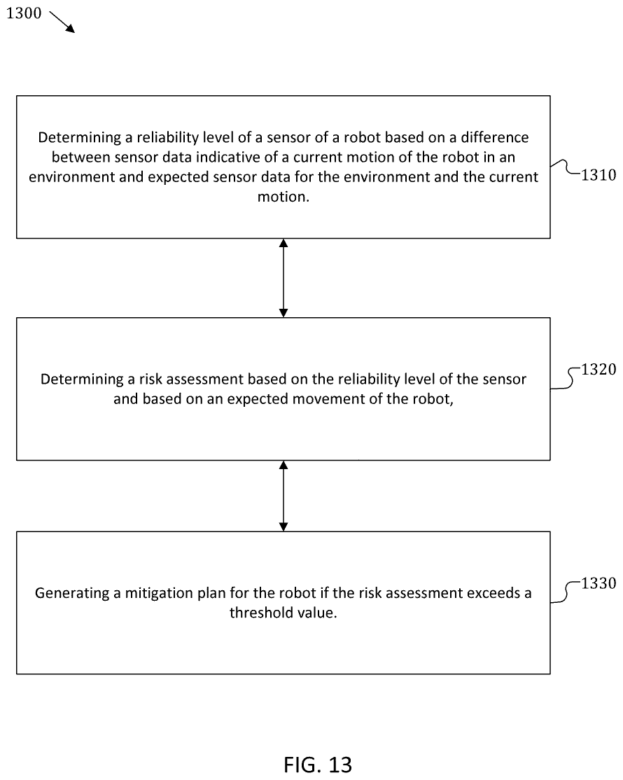

FIG. 13 depicts a schematic flow diagram of a method 1300 for improving the safety of a robot. Method 1300 may implement any of the features described above with respect to robot safety system 200, robot safety service system 300, integrity-checking system 1000, device 1100, and/or FIGS. 1-12.

Method 1300 includes, in 1310, determining a reliability level of a sensor of a robot based on a difference between sensor data indicative of a current motion of the robot in an environment and expected sensor data for the environment and the current motion. Method 1300 also includes, in 1320, determining a risk assessment based on the reliability level of the sensor and based on an expected movement of the robot. Method 1300 also includes, in 1330, generating a mitigation plan for the robot if the risk assessment exceeds a threshold value.

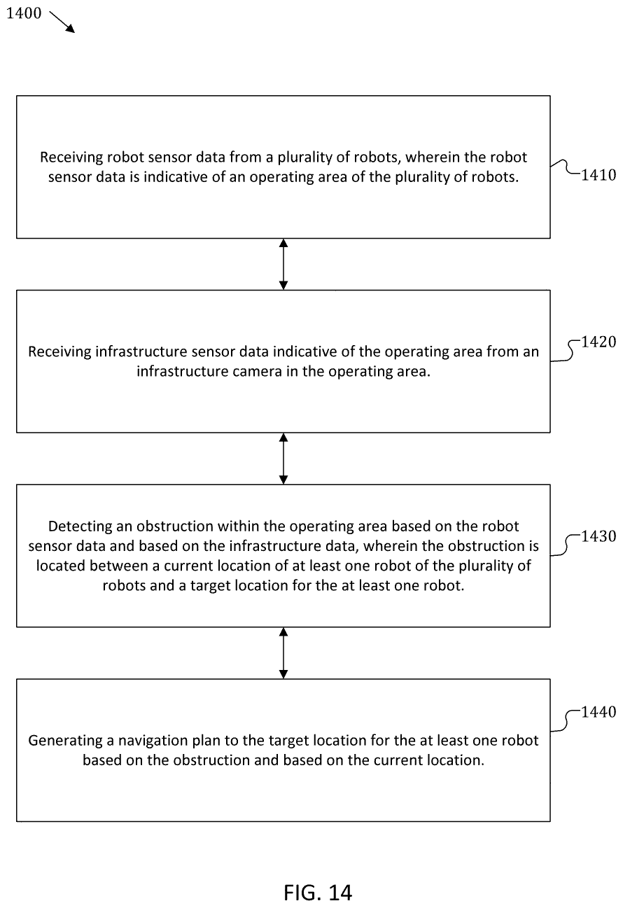

FIG. 14 depicts a schematic flow diagram of a method 1400 for improving the safety of a robot. Method 1400 may implement any of the features described above with respect to robot safety system 200, robot safety service system 300, integrity-checking system 1000, device 1100, and/or FIGS. 1-13.

Method 1400 includes, in 1410, receiving robot sensor data from a plurality of robots, wherein the robot sensor data is indicative of an operating area of the plurality of robots. Method 1400 also includes, in 1420, receiving infrastructure sensor data indicative of the operating area from an infrastructure camera in the operating area. Method 1400 also includes, in 1430, detecting an obstruction within the operating area based on the robot sensor data and based on the infrastructure data, wherein the obstruction is located between a current location of at least one robot of the plurality of robots and a target location for the at least one robot. Method 1400 also includes, in 1440, generating a navigation plan to the target location for the at least one robot based on the obstruction and based on the current location.

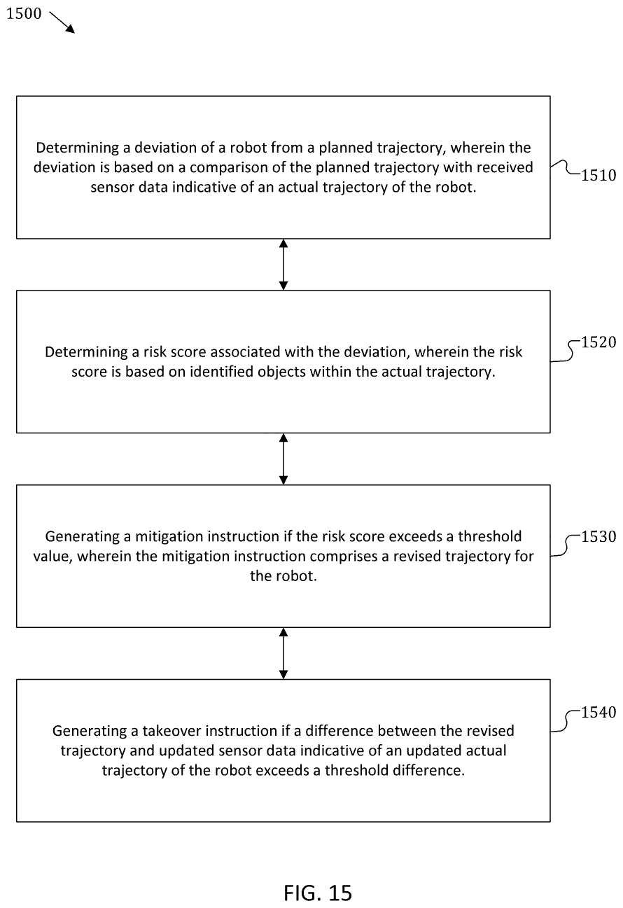

FIG. 15 depicts a schematic flow diagram of a method 1500 for improving the safety of a robot. Method 1500 may implement any of the features described above with respect to robot safety system 200, robot safety service system 300, integrity-checking system 1000, device 1100, and/or FIGS. 1-14.

Method 1500 includes, in 1510, determining a deviation of a robot from a planned trajectory, wherein the deviation is based on a comparison of the planned trajectory with received sensor data indicative of an actual trajectory of the robot. Method 1500 also includes, in 1520, determining a risk score associated with the deviation, wherein the risk score is based on identified objects within the actual trajectory. Method 1500 also includes, in 1530, generating a mitigation instruction if the risk score exceeds a threshold value, wherein the mitigation instruction includes a revised trajectory for the robot. Method 1500 also includes, in 1540, generating a takeover instruction if a difference between the revised trajectory and updated sensor data indicative of an updated actual trajectory of the robot exceeds a threshold difference.

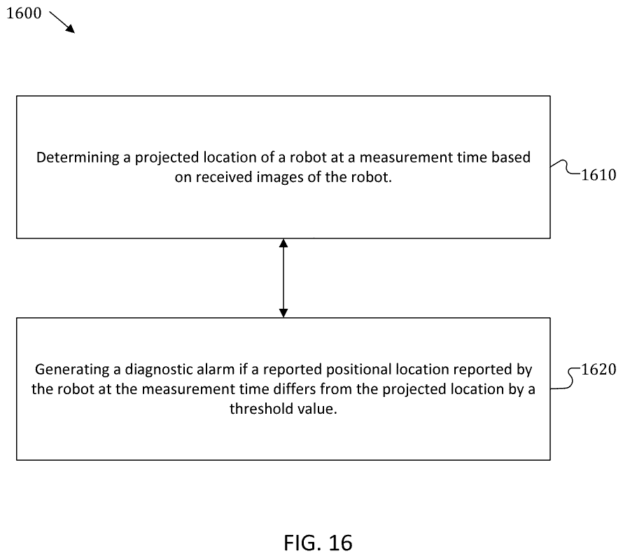

FIG. 16 depicts a schematic flow diagram of a method 1500 for improving the safety of a robot. Method 1600 may implement any of the features described above with respect to robot safety system 200, robot safety service system 300, integrity-checking system 1000, device 1100, and/or FIGS. 1-15.

Method 1600 includes, in 1610, determining a projected location of a robot at a measurement time based on received images of the robot. Method 1600 also includes, in 1620, generating a diagnostic alarm if a reported positional location reported by the robot at the measurement time differs from the projected location by a threshold value.

In the following, various examples are provided that may include one or more aspects described above with reference to robot safety system 200, robot safety service system 300, integrity-checking system 1000, device 1100, and/or FIGS. 1-16. The examples provided in relation to the devices may apply also to the described method(s), and vice versa.

Example 1 is a device that includes a processor configured to determine a safety envelope of a robot based on a planned movement of the robot and based on state information about a load carried by a robot, wherein the state information includes a dynamic status of the load. The processor is also configured to determine a safety risk based on a detected object with respect to the safety envelope. The processor is also configured to generate a mitigating action to the planned movement if the safety risk exceeds a threshold value.

Example 2 is the device of example 1, wherein the dynamic status of the load includes changes in at least one of a mass of the load, a shape of the load, a height of the load, a width of the load, a volume of the load, a mounting point of the load on the robot, or a distance of the load from a center of gravity of the robot.

Example 3 is the device of either example 1 or 2, wherein the planned movement of the robot includes at least one of a movement of the robot along a planned trajectory, a velocity of the movement of the robot along the planned trajectory, or a position of the robot along the planned trajectory.

Example 4 is the device of any one of examples 1 to 3, wherein the processor is configured to determine the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

Example 5 is the device of any one of examples 1 to 4, wherein the processor is configured to determine a predicted trajectory of the detected object based on at least one of past trajectories of other objects similar to the detected object, a velocity of the detected object, an acceleration of the detected object, a type of detected object, or a pose of the detected object.

Example 6 is the device of example 5, wherein the processor is configured to receive the past trajectories from a machine learning model associated with the other objects.

Example 7 is the device of any one of examples 1 to 6, wherein the processor is configured to receive the state information from a sensor configured to collect sensor data indicative of the state information.

Example 8 is the device of example 7, wherein the device further includes a receiver, wherein the processor is configured to receive the state information from the sensor via the receiver.

Example 9 is the device of either example 7 or 8, wherein the device further includes the sensor.

Example 10 is the device of any one of examples 1 to 9, wherein the device further includes a memory configured to store at least one of the safety envelope, the safety risk, or the mitigating action.

Example 11 is the device of any one of examples 1 to 10, wherein the robot is remote from the device.

Example 12 is a device including a processor configured to determine a reliability level of a sensor of a robot based on a difference between sensor data indicative of a current motion of the robot in an environment and expected sensor data for the environment and the current motion. The processor is also configured to determine a risk assessment based on the reliability level of the sensor and based on an expected movement of the robot. The processor is also configured to generate a mitigation plan for the robot if the risk assessment exceeds a threshold value.

Example 13 is the device of example 12, wherein the mitigation plan includes an instruction for the robot to calibrate the sensor.

Example 14 is the device of either example 12 or 13, wherein the mitigation plan includes an instruction for the robot to modify a parameter of the expected movement.

Example 15 is the device of example 14, wherein the parameter of the expected movement includes at least one of a speed, an acceleration, a trajectory, or a target location of the robot.

Example 16 is the device of any one of examples 12 to 15, wherein the processor is configured to receive the expected sensor data from a neural network model of trained sensor data.

Example 17 is the device of any one of examples 12 to 16, wherein the processor is configured to determine the risk assessment based on a location of identified objects within the environment

Example 18 is the device of any one of examples 12 to 17, wherein the processor is configured to determine the risk assessment based a magnitude of the difference between the sensor data and the expected sensor data.

Example 19 is the device of any one of examples 12 to 18, wherein the processor is configured to determine the risk assessment based a safety impact of the sensor data to the expected movement of the robot.

Example 20 is the device of any one of examples 12 to 19, wherein the processor is configured to determine the risk assessment based a type of the sensor.

Example 21 is a device including a processor configured to receive robot sensor data from a plurality of robots, wherein the robot sensor data is indicative of an operating area of the plurality of robots. The processor is also configured to receive infrastructure sensor data indicative of the operating area from an infrastructure camera in the operating area. The processor is also configured to detect an obstruction within the operating area based on the robot sensor data and based on the infrastructure data, wherein the obstruction is located between a current location of at least one robot of the plurality of robots and a target location for the at least one robot. The processor is also configured to generate a navigation plan to the target location for the at least one robot based on the obstruction and based on the current location.

Example 22 is the device of example 21, wherein the processor is further configured to determine the current location of the at least one robot based on a positional learning model that is compared to the infrastructure sensor data and robot sensor data.

Example 23 is the device of either example 21 or 22, wherein the obstruction includes a detected static object, a detected moving object, or a high risk area.

Example 24 is the device of any one of examples 21 to 23, wherein the processor is configured to detect the obstruction based on an object detection learning model that is compared to the infrastructure sensor data and robot sensor data.

Example 25 is the device of any one of examples 21 to 24, wherein the processor is further configured to detect an emergency event within the environment based on the robot sensor data or based on the infrastructure data. The processor is also configured to generate an emergency plan for the at least one robot based on a risk assessment of the emergency event, wherein the emergency plan includes at least one of a revised navigation plant to the target location, a right-of-way of the at least one robot to move within the environment, or a revised target location for the at least one robot that is different from the target location.

Example 26 is the device of any one of examples 21 to 25, further including a memory configured to store at least one of the robot sensor data, the infrastructure sensor data, or the navigation plan.

Example 27 is a device including a processor configured to determine a deviation of a robot from a planned trajectory, wherein the deviation is based on a comparison of the planned trajectory with received sensor data indicative of an actual trajectory of the robot. The processor is also configured to determine a risk score associated with the deviation, wherein the risk score is based on identified objects within the actual trajectory. The processor is also configured to generate a mitigation instruction if the risk score exceeds a threshold value, wherein the mitigation instruction includes a revised trajectory for the robot. The processor is also configured to generate a takeover instruction if a difference between the revised trajectory and updated sensor data indicative of an updated actual trajectory of the robot exceeds a threshold difference.

Example 28 is the device of example 27, wherein the device further includes a transmitter configured to transmit the mitigation instruction and the takeover instruction to the robot.

Example 29 is the device of example 28, wherein the takeover instruction includes an indication to activate to a safety subsystem of the robot.

Example 30 is the device of either example 28 or 29, wherein the transmitter is configured to transmit the mitigation instruction to the robot over a first communications channel, wherein the transmitter is configured to transmit the takeover instruction to the robot over a second communications channel, wherein the first communications channel is different from the second communications channel.

Example 31 is the device of any one of examples 27 to 30, wherein the mitigation instruction includes a transmission request for the robot to transmit diagnostic information to the device.

Example 32 is the device of any one of examples 27 to 31, wherein the device further includes a memory configured to store at least one of the deviation, the risk score, the mitigation instruction, or the takeover instruction.

Example 33 is a device including a processor configured to determine a projected location of a robot at a measurement time based on received images of the robot. The processor is further configured to generate a diagnostic alarm if a reported positional location reported by the robot at the measurement time differs from the projected location by a threshold value.

Example 34 is the device of example 33, wherein the device further includes a receiver, wherein the processor is configured to receive via the receiver the received images from a camera that is at a fixed location with respect to the robot.

Example 35 is the device of either example 33 or 34, wherein the device further includes a receiver, wherein the processor is configured to receive via the receiver the reported positional location from the robot.

Example 36 is the device of any one of examples 33 to 35, wherein the projected location is defined with respect to a first coordinate system, wherein the processor configured to determine the projected location includes the processor configured to convert an image position of the robot defined with respect to a second coordinate system into the projected location based on the fixed location of the camera, wherein the first coordinate system is different from the second coordinate system.

Example 37 is the device of example 36, wherein the first coordinate system includes a world coordinate system indicative of the robot within a world environment, wherein the second coordinate system includes an image coordinate system indicative of the robot within the received images.

Example 38 is the device of example 37, wherein the fixed location is defined with respect to the world coordinate system.

Example 39 is the device of any one of examples 33 to 38, wherein the device further includes a memory configured to store at least one of the projected location, the measurement time, the received images, the diagnostic alarm, or the threshold value.

Example 40 is the device of any one of examples 33 to 39, wherein the received images are associated with a first timeframe that is before the measurement time, wherein the processor is configured to determine the projected location based on an estimated trajectory of the robot in the first timeframe.

Example 41 is the device of any one of examples 33 to 40, wherein the diagnostic alarm includes a message indicating at least one of a request to perform a calibration, a request to perform a measurement, a perception malfunction associated with the received images, a motor malfunction of a motor on the robot, a motion control malfunction, or a communication malfunction of communications between the robot and the device.

Example 42 is a method including determining a safety envelope of a robot based on a planned movement of the robot and based on state information about a load carried by a robot, wherein the state information includes a dynamic status of the load. The method also includes determining a safety risk based on a detected object with respect to the safety envelope. The method also includes generating a mitigating action to the planned movement if the safety risk exceeds a threshold value.

Example 43 is the method of example 42, wherein the dynamic status of the load includes changes in at least one of a mass of the load, a shape of the load, a height of the load, a width of the load, a volume of the load, a mounting point of the load on the robot, or a distance of the load from a center of gravity of the robot.

Example 44 is the method of either example 42 or 43, wherein the planned movement of the robot includes at least one of a movement of the robot along a planned trajectory, a velocity of the movement of the robot along the planned trajectory, or a position of the robot along the planned trajectory.

Example 45 is the method of any one of examples 42 to 44, wherein the method includes determining the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

Example 46 is the method of any one of examples 42 to 45, wherein the method includes determining a predicted trajectory of the detected object based on at least one of past trajectories of other objects similar to the detected object, a velocity of the detected object, an acceleration of the detected object, a type of detected object, or a pose of the detected object.

Example 47 is the method of example 46, wherein the method includes receiving the past trajectories from a machine learning model associated with the other objects.

Example 48 is the method of any one of examples 42 to 47, wherein the method includes receiving the state information from a sensor configured to collect sensor data indicative of the state information.

Example 49 is the method of example 48, wherein the method includes receiving the state information from the sensor via a receiver.

Example 50 is the method of any one of examples 42 to 49, wherein the method further includes storing via a memory at least one of the safety envelope, the safety risk, or the mitigating action.

Example 51 is a method that includes determining a reliability level of a sensor of a robot based on a difference between sensor data indicative of a current motion of the robot in an environment and expected sensor data for the environment and the current motion. The method also includes determining a risk assessment based on the reliability level of the sensor and based on an expected movement of the robot. The method also includes generating a mitigation plan for the robot if the risk assessment exceeds a threshold value.

Example 52 is the method of example 51, wherein the mitigation plan includes an instruction for the robot to calibrate the sensor.

Example 53 is the method of either example 51 or 52, wherein the mitigation plan includes an instruction for the robot to modify a parameter of the expected movement.

Example 54 is the method of example 53, wherein the parameter of the expected movement includes at least one of a speed, an acceleration, a trajectory, or a target location of the robot.

Example 55 is the method of any one of examples 51 to 54, wherein the method includes receiving the expected sensor data from a neural network model of trained sensor data.

Example 56 is the method of any one of examples 51 to 55, wherein the method includes determining the risk assessment based on a location of identified objects within the environment

Example 57 is the method of any one of examples 51 to 56, wherein the method includes determining the risk assessment based a magnitude of the difference between the sensor data and the expected sensor data.

Example 58 is the method of any one of examples 51 to 57, wherein the method includes determining the risk assessment based a safety impact of the sensor data to the expected movement of the robot.

Example 59 is the method of any one of examples 51 to 58, wherein the method includes determining the risk assessment based a type of the sensor.

Example 60 is a method that includes receiving robot sensor data from a plurality of robots, wherein the robot sensor data is indicative of an operating area of the plurality of robots. The method also includes receiving infrastructure sensor data indicative of the operating area from an infrastructure camera in the operating area. The method also includes detecting an obstruction within the operating area based on the robot sensor data and based on the infrastructure data, wherein the obstruction is located between a current location of at least one robot of the plurality of robots and a target location for the at least one robot. The method also includes generating a navigation plan to the target location for the at least one robot based on the obstruction and based on the current location.

Example 61 is the method of example 60, wherein the method further includes determining the current location of the at least one robot based on a positional learning model that is compared to the infrastructure sensor data and robot sensor data.

Example 62 is the method of either example 60 or 61, wherein the obstruction includes a detected static object, a detected moving object, or a high risk area.

Example 63 is the method of any one of examples 60 to 62, wherein the method includes detecting the obstruction based on an object detection learning model that is compared to the infrastructure sensor data and robot sensor data.

Example 64 is the method of any one of examples 60 to 63, wherein the method further includes detecting an emergency event within the environment based on the robot sensor data or based on the infrastructure data. The method further includes generating an emergency plan for the at least one robot based on a risk assessment of the emergency event, wherein the emergency plan includes at least one of a revised navigation plant to the target location, a right-of-way of the at least one robot to move within the environment, or a revised target location for the at least one robot that is different from the target location.

Example 65 is the method of any one of examples 60 to 64, wherein the method further includes storing in a memory at least one of the robot sensor data, the infrastructure sensor data, or the navigation plan.

Example 66 is a method that includes determining a deviation of a robot from a planned trajectory, wherein the deviation is based on a comparison of the planned trajectory with received sensor data indicative of an actual trajectory of the robot. The method also includes determining a risk score associated with the deviation, wherein the risk score is based on identified objects within the actual trajectory. The method also includes generating a mitigation instruction if the risk score exceeds a threshold value, wherein the mitigation instruction includes a revised trajectory for the robot. The method also includes generating a takeover instruction if a difference between the revised trajectory and updated sensor data indicative of an updated actual trajectory of the robot exceeds a threshold difference.

Example 67 is the method of example 66, wherein the method further includes transmitting the mitigation instruction and the takeover instruction to the robot via a transmitter.

Example 68 is the method of example 67, wherein the takeover instruction includes an indication to activate to a safety subsystem of the robot.

Example 69 is the method of either example 67 or 68, wherein the method further includes transmitting the mitigation instruction over a first communications channel, wherein the method further includes transmitting the takeover instruction over a second communications channel, wherein the first communications channel is different from the second communications channel.

Example 70 is the method of any one of examples 66 to 69, wherein the mitigation instruction includes a transmission request for the robot to transmit diagnostic information.

Example 71 is the method of any one of examples 66 to 70, wherein the method further includes storing in a memory at least one of the deviation, the risk score, the mitigation instruction, or the takeover instruction.

Example 72 is a method that includes determining a projected location of a robot at a measurement time based on received images of the robot. The method further includes generating a diagnostic alarm if a reported positional location reported by the robot at the measurement time differs from the projected location by a threshold value.

Example 73 is the method of example 72, wherein the method also includes receiving via a receiver the received images from a camera that is at a fixed location with respect to the robot.

Example 74 is the method of either example 72 or 73, wherein the method further includes receiving via a receiver the reported positional location from the robot.

Example 75 is the method of any one of examples 72 to 74, wherein the projected location is defined with respect to a first coordinate system, determining the projected location includes converting an image position of the robot defined with respect to a second coordinate system into the projected location based on the fixed location of the camera, wherein the first coordinate system is different from the second coordinate system.

Example 76 is the method of example 75, wherein the first coordinate system includes a world coordinate system indicative of the robot within a world environment, wherein the second coordinate system includes an image coordinate system indicative of the robot within the received images.

Example 77 is the method of example 76, wherein the fixed location is defined with respect to the world coordinate system.

Example 78 is the method of any one of examples 72 to 77, wherein the method further includes storing in a memory at least one of the projected location, the measurement time, the received images, the diagnostic alarm, or the threshold value.

Example 79 is the method of any one of examples 72 to 78, wherein the received images are associated with a first timeframe that is before the measurement time, wherein the method includes determining the projected location based on an estimated trajectory of the robot in the first timeframe.

Example 80 is the method of any one of examples 72 to 79, wherein the diagnostic alarm includes a message indicating at least one of a request to perform a calibration, a request to perform a measurement, a perception malfunction associated with the received images, a motor malfunction of a motor on the robot, a motion control malfunction, or a communication malfunction of communications between the robot and the device

Example 81 is a device that includes a means for determining a safety envelope of a robot based on a planned movement of the robot and based on state information about a load carried by a robot, wherein the state information includes a dynamic status of the load. The device also includes a means for determining a safety risk based on a detected object with respect to the safety envelope. The device also includes a means for generating a mitigating action to the planned movement if the safety risk exceeds a threshold value.

Example 82 is the device of example 81, wherein the dynamic status of the load includes changes in at least one of a mass of the load, a shape of the load, a height of the load, a width of the load, a volume of the load, a mounting point of the load on the robot, or a distance of the load from a center of gravity of the robot.

Example 83 is the device of either example 81 or 82, wherein the planned movement of the robot includes at least one of a movement of the robot along a planned trajectory, a velocity of the movement of the robot along the planned trajectory, or a position of the robot along the planned trajectory.

Example 84 is the device of any one of examples 81 to 83, wherein the device also includes a means for determining the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

Example 85 is the device of any one of examples 81 to 84, wherein the device also includes a means for determining a predicted trajectory of the detected object based on at least one of past trajectories of other objects similar to the detected object, a velocity of the detected object, an acceleration of the detected object, a type of detected object, or a pose of the detected object.

Example 86 is the device of example 85, the device also includes a means for receiving the past trajectories from a machine learning model associated with the other objects.

Example 87 is the device of any one of examples 81 to 86, wherein the device also includes a means for receiving the state information from a sensing means for sensing sensor data indicative of the state information.

Example 88 is the device of example 87, wherein the device further includes the sensing means.

Example 89 is the device of any one of examples 81 to 88, wherein the device further includes a means for storing at least one of the safety envelope, the safety risk, or the mitigating action.

Example 90 is the device of any one of examples 81 to 89, wherein the robot is remote from the device.

Example 91 is a device including a means for determining a reliability level of a sensing means of a robot based on a difference between sensor data indicative of a current motion of the robot in an environment and expected sensor data for the environment and the current motion. The device also includes a means for determining a risk assessment based on the reliability level of the sensing means and based on an expected movement of the robot. The device also includes a means for generating a mitigation plan for the robot if the risk assessment exceeds a threshold value.

Example 92 is the device of example 91, wherein the mitigation plan includes an instruction for the robot to calibrate the sensing means.

Example 93 is the device of either example 91 or 92, wherein the mitigation plan includes an instruction for the robot to modify a parameter of the expected movement.

Example 94 is the device of example 93, wherein the parameter of the expected movement includes at least one of a speed, an acceleration, a trajectory, or a target location of the robot.

Example 95 is the device of any one of examples 91 to 94, wherein device further includes a means for receiving the expected sensor data from a neural network model of trained sensor data.

Example 96 is the device of any one of examples 91 to 95, wherein the means for determining the risk assessment includes a means for determining the risk assessment based on a location of identified objects within the environment

Example 97 is the device of any one of examples 91 to 96, wherein the means for determining the risk assessment includes a means for determining the risk assessment based a magnitude of the difference between the sensor data and the expected sensor data.

Example 98 is the device of any one of examples 91 to 97, wherein the means for determining the risk assessment includes a means for determining the risk assessment based a safety impact of the sensor data to the expected movement of the robot.

Example 99 is the device of any one of examples 91 to 98, wherein the means for determining the risk assessment includes a means for determining the risk assessment based a type of the sensing means.

Example 100 is a device including a means for receiving robot sensor data from a plurality of robots, wherein the robot sensor data is indicative of an operating area of the plurality of robots. The device further includes a means for receiving infrastructure sensor data indicative of the operating area from an infrastructure camera in the operating area. The device further includes a means for detecting an obstruction within the operating area based on the robot sensor data and based on the infrastructure data, wherein the obstruction is located between a current location of at least one robot of the plurality of robots and a target location for the at least one robot. The device further includes a means for generating a navigation plan to the target location for the at least one robot based on the obstruction and based on the current location.

Example 101 is the device of example 100, wherein device includes a means for determining the current location of the at least one robot based on a positional learning model that is compared to the infrastructure sensor data and robot sensor data.

Example 102 is the device of either example 100 or 101, wherein the obstruction includes a detected static object, a detected moving object, or a high risk area.

Example 103 is the device of any one of examples 100 to 102, wherein the device includes a means for detecting the obstruction based on an object detection learning model that is compared to the infrastructure sensor data and robot sensor data.

Example 104 is the device of any one of examples 100 to 103, wherein the device includes a means for detecting an emergency event within the environment based on the robot sensor data or based on the infrastructure data. The device also includes a means for generating an emergency plan for the at least one robot based on a risk assessment of the emergency event, wherein the emergency plan includes at least one of a revised navigation plant to the target location, a right-of-way of the at least one robot to move within the environment, or a revised target location for the at least one robot that is different from the target location.

Example 105 is the device of any one of examples 100 to 104, wherein the device further includes a means storing at least one of the robot sensor data, the infrastructure sensor data, or the navigation plan.

Example 106 is a device that includes a means for determining a deviation of a robot from a planned trajectory, wherein the deviation is based on a comparison of the planned trajectory with received sensor data indicative of an actual trajectory of the robot. The device also includes a means for determining a risk score associated with the deviation, wherein the risk score is based on identified objects within the actual trajectory. The device also includes a means for generating a mitigation instruction if the risk score exceeds a threshold value, wherein the mitigation instruction includes a revised trajectory for the robot. The device also includes a means for generating a takeover instruction if a difference between the revised trajectory and updated sensor data indicative of an updated actual trajectory of the robot exceeds a threshold difference.

Example 107 is the device of example 106, wherein the device also includes a means for transmitting the mitigation instruction and the takeover instruction to the robot.

Example 108 is the device of example 107, wherein the takeover instruction includes an indication to activate to a safety subsystem of the robot.

Example 109 is the device of either example 107 or 108, wherein the means for transmitting includes a means for transmitting the mitigation instruction to the robot over a first communications channel, wherein the means for transmitting also includes a means for transmitting the takeover instruction to the robot over a second communications channel, wherein the first communications channel is different from the second communications channel.

Example 110 is the device of any one of examples 106 to 109, wherein the mitigation instruction includes a transmission request for the robot to transmit diagnostic information to the device.

Example 111 is the device of any one of examples 106 to 110, wherein the device further includes a means for storing at least one of the deviation, the risk score, the mitigation instruction, or the takeover instruction.

Example 112 is a device that includes a means for determining a projected location of a robot at a measurement time based on received images of the robot. The device also includes a means for generating a diagnostic alarm if a reported positional location reported by the robot at the measurement time differs from the projected location by a threshold value.

Example 113 is the device of example 112, wherein device also includes a means for receiving the received images from a means for imaging that is at a fixed location with respect to the robot.

Example 114 is the device of either example 112 or 113, wherein the device further includes a means for receiving the reported positional location from the robot.

Example 115 is the device of any one of examples 112 to 114, wherein the projected location is defined with respect to a first coordinate system, wherein means for determining the projected location includes a means for converting an image position of the robot defined with respect to a second coordinate system into the projected location based on the fixed location of the camera, wherein the first coordinate system is different from the second coordinate system.

Example 116 is the device of example 115, wherein the first coordinate system includes a world coordinate system indicative of the robot within a world environment, wherein the second coordinate system includes an image coordinate system indicative of the robot within the received images.

Example 117 is the device of example 116, wherein the fixed location is defined with respect to the world coordinate system.

Example 118 is the device of any one of examples 112 to 117, wherein the device further includes a means for storing at least one of the projected location, the measurement time, the received images, the diagnostic alarm, or the threshold value.

Example 119 is the device of any one of examples 112 to 118, wherein the received images are associated with a first timeframe that is before the measurement time, wherein the device includes a means for determining the projected location based on an estimated trajectory of the robot in the first timeframe.

Example 120 is the device of any one of examples 112 to 119, wherein the diagnostic alarm includes a message indicating at least one of a request to perform a calibration, a request to perform a measurement, a perception malfunction associated with the received images, a motor malfunction of a motor on the robot, a motion control malfunction, or a communication malfunction of communications between the robot and the device.

Example 121 is a non-transitory computer readable medium, including instructions which, if executed, cause a processor to determine a safety envelope of a robot based on a planned movement of the robot and based on state information about a load carried by a robot, wherein the state information includes a dynamic status of the load. The instructions are also configured to cause the processor to determine a safety risk based on a detected object with respect to the safety envelope. The instructions are also configured to cause the processor to generate a mitigating action to the planned movement if the safety risk exceeds a threshold value.

Example 122 is the non-transitory computer readable medium of example 121, wherein the dynamic status of the load includes changes in at least one of a mass of the load, a shape of the load, a height of the load, a width of the load, a volume of the load, a mounting point of the load on the robot, or a distance of the load from a center of gravity of the robot.

Example 123 is the non-transitory computer readable medium of either example 121 or 122, wherein the planned movement of the robot includes at least one of a movement of the robot along a planned trajectory, a velocity of the movement of the robot along the planned trajectory, or a position of the robot along the planned trajectory.

Example 124 is the non-transitory computer readable medium of any one of examples 121 to 123, wherein the instructions are also configured to cause the processor to determine the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

Example 125 is the non-transitory computer readable medium of any one of examples 121 to 124, wherein the instructions are also configured to cause the processor to determine a predicted trajectory of the detected object based on at least one of past trajectories of other objects similar to the detected object, a velocity of the detected object, an acceleration of the detected object, a type of detected object, or a pose of the detected object.

Example 126 is the non-transitory computer readable medium of example 125, wherein the instructions are also configured to cause the processor to receive the past trajectories from a machine learning model associated with the other objects.

Example 127 is the non-transitory computer readable medium of any one of examples 121 to 126, wherein the instructions are also configured to cause the processor to receive the state information from a sensor, wherein instructions are also configured to cause the sensor to collect sensor data indicative of the state information.

Example 128 is the non-transitory computer readable medium of example 127, wherein the instructions are further configured to cause the processor to receive the state information from the sensor via a receiver.

Example 129 is the non-transitory computer readable medium of either example 127 or 128, wherein the non-transitory computer readable medium further includes the sensor.

Example 130 is the non-transitory computer readable medium of any one of examples 121 to 129, wherein instructions are also configured to cause the processor store in a memory at least one of the safety envelope, the safety risk, or the mitigating action.

Example 131 is the non-transitory computer readable medium of any one of examples 121 to 130, wherein the robot is remote from the non-transitory computer readable medium.

Example 132 is a non-transitory computer readable medium, including instructions which, if executed, cause a processor to determine a reliability level of a sensor of a robot based on a difference between sensor data indicative of a current motion of the robot in an environment and expected sensor data for the environment and the current motion. The instructions are also configured to cause the processor to determine a risk assessment based on the reliability level of the sensor and based on an expected movement of the robot. The instructions are also configured to cause the processor to generate a mitigation plan for the robot if the risk assessment exceeds a threshold value.

Example 133 is the non-transitory computer readable medium of example 132, wherein the mitigation plan includes an instruction for the robot to calibrate the sensor.

Example 134 is the non-transitory computer readable medium of either example 132 or 133, wherein the mitigation plan includes an instruction for the robot to modify a parameter of the expected movement.

Example 135 is the non-transitory computer readable medium of example 134, wherein the parameter of the expected movement includes at least one of a speed, an acceleration, a trajectory, or a target location of the robot.

Example 136 is the non-transitory computer readable medium of any one of examples 132 to 135, wherein the instructions are configured to cause the processor to receive the expected sensor data from a neural network model of trained sensor data.

Example 137 is the non-transitory computer readable medium of any one of examples 132 to 136, wherein the instructions are configured to cause the processor to determine the risk assessment based on a location of identified objects within the environment

Example 138 is the non-transitory computer readable medium of any one of examples 132 to 137, wherein the instructions are configured to cause the processor to determine the risk assessment based a magnitude of the difference between the sensor data and the expected sensor data.

Example 139 is the non-transitory computer readable medium of any one of examples 132 to 138, wherein the instructions are configured to cause the processor to determine the risk assessment based a safety impact of the sensor data to the expected movement of the robot.

Example 140 is the non-transitory computer readable medium of any one of examples 132 to 139, wherein the instructions are configured to cause the processor to determine the risk assessment based a type of the sensor.

Example 141 is a non-transitory computer readable medium, including instructions which, if executed, cause a processor to receive robot sensor data from a plurality of robots, wherein the robot sensor data is indicative of an operating area of the plurality of robots. The instructions are also configured to cause the processor to receive infrastructure sensor data indicative of the operating area from an infrastructure camera in the operating area. The instructions are also configured to cause the processor to detect an obstruction within the operating area based on the robot sensor data and based on the infrastructure data, wherein the obstruction is located between a current location of at least one robot of the plurality of robots and a target location for the at least one robot. The instructions are also configured to cause the processor to generate a navigation plan to the target location for the at least one robot based on the obstruction and based on the current location.

Example 142 is the non-transitory computer readable medium of example 141, wherein the instructions are configured to cause the processor to determine the current location of the at least one robot based on a positional learning model that is compared to the infrastructure sensor data and robot sensor data.

Example 143 is the non-transitory computer readable medium of either example 141 or 142, wherein the obstruction includes a detected static object, a detected moving object, or a high risk area.

Example 144 is the non-transitory computer readable medium of any one of examples 141 to 143, wherein the instructions are configured to cause the processor to detect the obstruction based on an object detection learning model that is compared to the infrastructure sensor data and robot sensor data.

Example 145 is the non-transitory computer readable medium of any one of examples 141 to 144, wherein the instructions are configured to cause the processor to detect an emergency event within the environment based on the robot sensor data or based on the infrastructure data. The instructions are also configured to cause the processor to generate an emergency plan for the at least one robot based on a risk assessment of the emergency event, wherein the emergency plan includes at least one of a revised navigation plant to the target location, a right-of-way of the at least one robot to move within the environment, or a revised target location for the at least one robot that is different from the target location.

Example 146 is the non-transitory computer readable medium of any one of examples 141 to 145, further including a memory, wherein the instructions are configured to cause the memory to store at least one of the robot sensor data, the infrastructure sensor data, or the navigation plan.

Example 147 is a non-transitory computer readable medium, including instructions which, if executed, cause a processor to determine a deviation of a robot from a planned trajectory, wherein the deviation is based on a comparison of the planned trajectory with received sensor data indicative of an actual trajectory of the robot. The instructions are also configured to cause the processor to determine a risk score associated with the deviation, wherein the risk score is based on identified objects within the actual trajectory. The instructions are also configured to cause the processor to generate a mitigation instruction if the risk score exceeds a threshold value, wherein the mitigation instruction includes a revised trajectory for the robot. The instructions are also configured to cause the processor to generate a takeover instruction if a difference between the revised trajectory and updated sensor data indicative of an updated actual trajectory of the robot exceeds a threshold difference.

Example 148 is the non-transitory computer readable medium of example 147, wherein the non-transitory computer readable medium further includes a transmitter, wherein instructions are configured to cause the transmitter to transmit the mitigation instruction and the takeover instruction to the robot.

Example 149 is the non-transitory computer readable medium of example 148, wherein the takeover instruction includes an indication to activate to a safety subsystem of the robot.

Example 150 is the non-transitory computer readable medium of either example 148 or 149, wherein the instructions are configured to cause the transmitter to transmit the mitigation instruction to the robot over a first communications channel, wherein the instructions are further configured to cause the transmitter to transmit the takeover instruction to the robot over a second communications channel, wherein the first communications channel is different from the second communications channel.

Example 151 is the non-transitory computer readable medium of any one of examples 147 to 150, wherein the mitigation instruction includes a transmission request for the robot to transmit diagnostic information to the non-transitory computer readable medium.

Example 152 is the non-transitory computer readable medium of any one of examples 147 to 151, wherein the non-transitory computer readable medium further includes a memory, wherein the instructions are configured to cause the memory to store at least one of the deviation, the risk score, the mitigation instruction, or the takeover instruction.

Example 153 is a non-transitory computer readable medium, including instructions which, if executed, cause a processor to determine a projected location of a robot at a measurement time based on received images of the robot. The instructions are also configured to cause the processor to generate a diagnostic alarm if a reported positional location reported by the robot at the measurement time differs from the projected location by a threshold value.

Example 154 is the non-transitory computer readable medium of example 153, wherein the non-transitory computer readable medium further includes a receiver, wherein the instructions are configured to cause the processor to receive via the receiver the received images from a camera that is at a fixed location with respect to the robot.

Example 155 is the non-transitory computer readable medium of either example 153 or 154, wherein the non-transitory computer readable medium further includes a receiver, wherein the instructions are configured to cause the processor to receive via the receiver the reported positional location from the robot.

Example 156 is the non-transitory computer readable medium of any one of examples 153 to 155, wherein the projected location is defined with respect to a first coordinate system, wherein the instructions configured to cause the processor to determine the projected location includes the instructions are also configured to cause the processor to convert an image position of the robot defined with respect to a second coordinate system into the projected location based on the fixed location of the camera, wherein the first coordinate system is different from the second coordinate system.

Example 157 is the non-transitory computer readable medium of example 156, wherein the first coordinate system includes a world coordinate system indicative of the robot within a world environment, wherein the second coordinate system includes an image coordinate system indicative of the robot within the received images.

Example 158 is the non-transitory computer readable medium of example 157, wherein the fixed location is defined with respect to the world coordinate system.

Example 159 is the non-transitory computer readable medium of any one of examples 153 to 158, wherein the non-transitory computer readable medium further includes a memory, wherein the instructions are configured to cause the memory to store at least one of the projected location, the measurement time, the received images, the diagnostic alarm, or the threshold value.

Example 160 is the non-transitory computer readable medium of any one of examples 153 to 159, wherein the received images are associated with a first timeframe that is before the measurement time, wherein the instructions are configured to cause the processor to determine the projected location based on an estimated trajectory of the robot in the first timeframe.

Example 161 is the non-transitory computer readable medium of any one of examples 153 to 160, wherein the diagnostic alarm includes a message indicating at least one of a request to perform a calibration, a request to perform a measurement, a perception malfunction associated with the received images, a motor malfunction of a motor on the robot, a motion control malfunction, or a communication malfunction of communications between the robot and the non-transitory computer readable medium.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

claimed is:

1. A device comprising a processor configured to:
determine a safety envelope of a robot based on a planned movement of the robot and based on state information about a load carried by a robot, wherein the state information comprises a dynamic status of the load;
determine a safety risk based on a detected object with respect to the safety envelope; and
generate a mitigating action to the planned movement if the safety risk exceeds a threshold value.

2. The device of claim 1, wherein the dynamic status of the load comprises changes in at least one of a mass of the load, a shape of the load, a height of the load, a width of the load, a volume of the load, a mounting point of the load on the robot, or a distance of the load from a center of gravity of the robot.

3. The device of claim 1, wherein the planned movement of the robot comprises at least one of a movement of the robot along a planned trajectory, a velocity of the movement of the robot along the planned trajectory, or a position of the robot along the planned trajectory.

4. The device of claim 1, wherein the processor is configured to determine the safety envelope based on at least one of a threshold breaking distance of the robot with the load, a threshold turn radius of the robot with the load, a velocity of the planned movement of the robot with the load, a trajectory of the planned movement of the robot with the load, or an acceleration of the planned movement of the robot with the load.

5. The device of claim 1, wherein the processor is configured to determine a predicted trajectory of the detected object based on at least one of past trajectories of other objects similar to the detected object, a velocity of the detected object, an acceleration of the detected object, a type of detected object, or a pose of the detected object.

6. The device of claim 5, wherein the processor is configured to receive the past trajectories from a machine learning model associated with the other objects.

7. The device of claim 1, wherein the processor is configured to receive the state information from a sensor configured to collect sensor data indicative of the state information.

8. A device comprising a processor configured to:
determine a deviation of a robot from a planned trajectory, wherein the deviation is based on a comparison of the planned trajectory with received sensor data indicative of an actual trajectory of the robot;
determine a risk score associated with the deviation, wherein the risk score is based on identified objects within the actual trajectory; and
generate a mitigation instruction if the risk score exceeds a threshold value, wherein the mitigation instruction comprises a revised trajectory for the robot;
generate a takeover instruction if a difference between the revised trajectory and updated sensor data indicative of an updated actual trajectory of the robot exceeds a threshold difference.

9. The device of claim 8, the device further comprising a transmitter configured to transmit the mitigation instruction and the takeover instruction to the robot.

10. The device of claim 8, wherein the takeover instruction comprises an indication to activate to a safety subsystem of the robot.

11. The device of claim 9, wherein the transmitter is configured to transmit the mitigation instruction to the robot over a first communications channel, wherein the transmitter is configured to transmit the takeover instruction to the robot over a second communications channel, wherein the first communications channel is different from the second communications channel.

12. The device of claim 8, wherein the mitigation instruction comprises a transmission request for the robot to transmit diagnostic information to the device.

13. The device of claim 8, further comprising a memory configured to store at least one of the deviation, the risk score, the mitigation instruction, or the takeover instruction.

14. A device comprising a processor configured to:
determine a projected location of a robot at a measurement time based on received images of the robot;
generate a diagnostic alarm if a reported positional location reported by the robot at the measurement time differs from the projected location by a threshold value.

15. The device of claim 14, further comprising a receiver, wherein the processor is configured to receive via the receiver the received images from a camera that is at a fixed location with respect to the robot.

16. The device of claim 14, wherein the projected location is defined with respect to a first coordinate system, wherein the processor configured to determine the projected location comprises the processor configured to convert an image position of the robot defined with respect to a second coordinate system into the projected location based on the fixed location of the camera, wherein the first coordinate system is different from the second coordinate system.

17. The device of claim 16, wherein the first coordinate system comprises a world coordinate system indicative of the robot within a world environment, wherein the second coordinate system comprises an image coordinate system indicative of the robot within the received images.

18. The device of claim 14, further comprising a memory configured to store at least one of the projected location, the measurement time, the received images, the diagnostic alarm, or the threshold value.

19. The device of claim 14, wherein the received images are associated with a first timeframe that is before the measurement time, wherein the processor is configured to determine the projected location based on an estimated trajectory of the robot in the first timeframe.

20. The device of claim 14, wherein the diagnostic alarm comprises a message indicating at least one of a request to perform a calibration, a request to perform a measurement, a perception malfunction associated with the received images, a motor malfunction of a motor on the robot, a motion control malfunction, or a communication malfunction of communications between the robot and the device.

21. A device comprising:
a means for determining a reliability level of a sensing means of a robot based on a difference between sensor data indicative of a current motion of the robot in an environment and expected sensor data for the environment and the current motion;
a means for determining a risk assessment based on the reliability level of the sensing means and based on an expected movement of the robot; and
a means for generating a mitigation plan for the robot if the risk assessment exceeds a threshold value.

22. The device of claim 21, wherein the mitigation plan comprises an instruction for the robot to calibrate the sensing means.

23. The device of claim 21, wherein the mitigation plan comprises an instruction for the robot to modify a parameter of the expected movement.

24. The device of claim 23, wherein the parameter of the expected movement comprises at least one of a speed, an acceleration, a trajectory, or a target location of the robot.

25. The device of claim 21, wherein the device further comprises a means for receiving the expected sensor data from a neural network model of trained sensor data.
